(19) United States
(12) Patent Application Publication
(10) Pub. No.: US 2026/0301483 A1
(43) Pub. Date: Oct. 1, 2026

(54) SYSTEM AND METHOD FOR PROGNOSTICS ENABLED MAINTENANCE PLANNING

(71) Applicant: Textron Innovations Inc., Providence, RI (US)

(72) Inventors: Brian Edward Tucker, Fort Worth, TX (US); JiYou Yoon Wolinski, Arlington, TX (US); Andrew Ervin Roy Tunison, North Richland Hills, TX (US)

(21) Appl. No.: 19/091,569

(22) Filed: Mar. 26, 2025

(51) Int. Cl. G07C 5/08; B64F 5/60; G06Q 10/20; G07C 5/00

(52) U.S. Cl. CPC G07C 5/0816; B64F 5/60; G06Q 10/20; G07C 5/006

(57) ABSTRACT

A method includes selecting a candidate mission, the candidate mission includes a mission type profile, selecting a candidate vehicle to undergo the candidate mission, identifying components of the candidate vehicle, the components being associated with the candidate vehicle in relation to the candidate mission, providing a current condition value for the candidate vehicle based on condition data of the components, generating one or more health models for the components, combining the one or more health models into a baseline risk profile for the vehicle, providing a first alert signal to indicate prognostication of whether the baseline risk profile passes above a risk threshold, selecting a first component for a first maintenance procedure, generating, based in part on the first maintenance procedure, an adjusted risk profile for the candidate vehicle, and providing a second alert signal to indicate prognostication of whether the adjusted risk profile passes above the risk threshold.

### STATEMENT ON UNITED STATES GOVERNMENT RIGHTS

This invention was made with U.S. Government support under Agreement No. W911W6-19-9-0002 awarded by the Army Contracting Command-Redstone Arsenal. The Government has certain rights in the invention.

### TECHNICAL FIELD

The present invention relates generally to a system and method for planning maintenance of a vehicle, and, in particular embodiments, to a system and method for planning maintenance of essential components of a vehicle undergoing a particular mission or mission type.

### BACKGROUND

A vehicle, such as a rotorcraft, may include one or more rotor systems including one or more main rotor systems. A main rotor system generates aerodynamic lift to support the weight of the rotorcraft in flight and thrust to move the rotorcraft in forward flight. Another example of a rotorcraft rotor system is a tail rotor system. A tail rotor system may generate thrust in the same direction as the main rotor system's rotation to counter the torque effect created by the main rotor system. For smooth and efficient flight in a rotorcraft, a pilot balances the engine power, main rotor collective thrust, main rotor cyclic thrust and the tail rotor thrust, and a control system may assist the pilot in stabilizing the rotorcraft and reducing pilot workload. The systems for engines, transmissions, drive system, rotors, and the like, are critical to the safe operation of the rotorcraft in flight. The elements of system such as mechanical systems, electrical systems, hydraulic systems, and the like, are each subject to unique wear factors and monitoring, inspection or maintenance requirements.

Many rotorcraft (and other vehicles) are fitted with condition and health monitoring equipment to determine when components or operating elements may wear out. For example, a rotorcraft may have a health and usage monitoring system (HUMS) which may use vibration and/or speed data (from accelerometers and tachometers) to determine the condition of components of a drivetrain or rotor. To do so, the condition data, such as raw sensor data received from a sensor, processed data acquired from raw sensor data or a sensor signal, or the like is processed, and features are extracted from the processed data. These features are called “condition indicators” (CIs), and the CIs may be monitored over time to find changes in performance, for example, by monitoring features such as vibration, that may indicate a change in the state of the monitored component. The possible states may include, for example, “healthy” or “deteriorated.” When the state of a monitored component deteriorates past an acceptable point, an alert condition may be identified, and an alert may be triggered to notify the relevant personnel to address the alert condition. When an alert condition is triggered during a flight or mission (e.g., mission type), important and time-sensitive decisions may have to be made about whether to continue, abort, and/or perform maintenance.

Operators of high technology vehicles (e.g., aircraft operated by the United States military) desire to operate the vehicles for periods of time (e.g., maintenance free operating period) with low risk of unscheduled maintenance (which may lead to mission aborts). Prognostic predictions of remaining useful life of certain essential components may enable such requirements and objectives. However, planning the optimal maintenance actions at the right time based on this information can be complex. For a single component, this may be straightforward or trivial. However, managing the number of components (even limited to a select subset comprising the most essential components) on a modern aircraft with dynamic maintenance environments may dictate a need to effectively evaluate a large number of maintenance scenarios.

Maintenance of the components on the rotorcraft is an on-going process. However, maintenance is costly in terms of money, time, and resources-all of which being limited. Maintenance of a component may be scheduled or unscheduled. For example, scheduled maintenance may be administered based in part on a maintenance schedule for the component. In addition, unscheduled maintenance may be required when a component is close to failure or outright fails, which may also be referred to as on-condition maintenance. Further, predictive maintenance of a component may be performed or scheduled when CIs may suggest the component is on track to fail before the scheduled maintenance and, therefore, technically falls outside the scope of the maintenance schedule.

In light of the foregoing, unnecessary maintenance has the effect of being additionally costly because the associated costs (e.g., money, time, and/or resources) may otherwise be applied to other maintenance or projects. Unnecessary maintenance often occurs when a maintenance schedule highly overestimates the rate at which the health of the corresponding component has decreased during past usage or will decrease over future usage. For example, the maintenance schedule may assume a rate of degradation for the component in relation to flight hours in use due to loads on the component during such use. However, the component may experience varying loads per flight hour depending on the actual operations of the corresponding flights. For example, if the component has undergone a past usage which includes flights with substantially light loads on the component, the component may now be in better health than what is implied by the maintenance schedule. As such, maintenance of the component based on the maintenance schedule may be unnecessary due to being premature. Alternatively, the component may have undergone a past usage which includes flights with substantially heavy loads on the component, the component may now be in worse health than what is implied by the maintenance schedule. As such, maintenance of the component based on the maintenance schedule may be too late.

Planning for a future mission involves balancing the costs of maintenance (e.g., money, time, and resources) with risks of failure of various components. As such, planning would benefit from knowing which components may require maintenance during the mission, and how scheduling maintenance for some of those components may keep an overall risk of failure below a failure threshold.

### SUMMARY

Embodiments disclosed herein provide a maintenance planning system (MPS), which is a system and method for planning maintenance before beginning a mission. The MPS assists a user in deciding which components on which to perform maintenance and at which points during the future mission to perform that maintenance. Note that elements of the disclosed MPS may also be utilized before a flight during an-ongoing mission.

To address inconsistencies between the actual rate and the expected rate at which the health of a component deteriorates, the health of the component may be monitored by acquiring and analyzing historical CI data. In addition, the health of the component as determined by the CI data may be extrapolated to calculate a probability of failure (or remaining useful life) for the component over subsequent usage in the vehicle. For example, expected loads of future flights (e.g., a mission or mission type comprising one or more flights) may be considered in the extrapolation. Typically, a plurality of components may be deemed particularly essential for the vehicle during the future flights. In particular, identification of these essential components may be based on the vehicle as well as parameters of the future flights (e.g., parameters of the mission type). As such, health assessments and extrapolations may be generated for all of the essential components.

In accordance with various embodiments discussed herein, the health extrapolations for the essential components may be compiled into a single risk profile for the vehicle at large. In fact, the risk profile may track an increasing risk of failure for the vehicle over the course of the mission or mission type, which may include one or more flights. Maintenance actions on some of the essential components may then be considered at different flights of the mission type or between mission types. Each possible maintenance action would influence the corresponding essential component, which would also influence the vehicle risk profile. As such, additional risk profiles may be generated based on various combinations of maintenance actions (e.g., maintenance scenarios). The assortment of risk profiles may then be compared to identify one or more preferred or optimal maintenance scenarios.

The MPS provides a prediction of when an essential component may need to be repaired, replaced, etc., in order to avoid unnecessary or premature maintenance and to prevent failure. For example, the MPS may be utilized in decisions to perform preventative maintenance before a flight or mission type. Risk profiles generated through the MPS give an indication of how much usage (e.g., flights or flight hours) remains before the component has a high risk of failure or needed maintenance. Measurements or observations of the components may be used by the MPS to estimate current health values and future trends of the components as a function of time. Embodiments discussed herein may apply to a variety of components of an aircraft. For example, in a gear box, a sensor may determine the content of oil or measure vibration to predict failure. When compiling a risk profile for a large number of components, the risk level is determined as a function of time in order for determinations to be made as to which components should receive preventative maintenance and when.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic illustrating a rotorcraft, in accordance with some embodiments;

FIG. 2 is a block diagram illustrating a fly-by-wire control system for a rotorcraft, in accordance with some embodiments;

FIG. 3 is a block diagram illustrating a health and usage monitoring system (HUMS) for the gathering, processing, and analyzing of condition indicators, in accordance with some embodiments;

FIG. 4 is a block diagram illustrating a maintenance planning system for a vehicle, in accordance with some embodiments;

FIG. 5 is a diagram illustrating a maintenance outline for a vehicle, in accordance with some embodiments;

FIG. 6 is a graph illustrating a health assessment and extrapolation for a component of a vehicle, in accordance with some embodiments;

FIGS. 7A-7C, 8, and 9 are interface features illustrating intermediate uses of a maintenance planning system, in accordance with some embodiments;

FIGS. 10A-10D are interface features illustrating intermediate uses of a maintenance planning system, in accordance with some embodiments;

FIGS. 11A and 11B are interface features illustrating intermediate uses of a maintenance planning system, in accordance with some embodiments; and

FIG. 12 is a diagram illustrating a computer system that may be used to implement a system, data terminal, or data server of a maintenance planning system, in accordance with some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The increasing use of rotorcraft, in particular, for commercial and industrial applications, has led to the development of larger more complex rotorcraft. However, as rotorcraft become larger and more complex, the differences between flying rotorcraft and fixed wing aircraft has become more pronounced. Since rotorcraft use one or more main rotors to simultaneously provide lift, control attitude, control altitude, and provide lateral or positional movement, different flight parameters and controls are tightly coupled to each other, as the aerodynamic characteristics of the main rotors affect each control and movement axis. For example, the flight characteristics of a rotorcraft at cruising speed or high speed may be significantly different than the flight characteristics at hover or at relatively low speeds. Additionally, different flight control inputs for different axes on the main rotor, such as cyclic inputs or collective inputs, affect other flight controls or flight characteristics of the rotorcraft. For example, pitching the nose of a rotorcraft forward to increase forward speed will generally cause the rotorcraft to lose altitude. In such a situation, the collective may be increased to maintain level flight, but the increase in collective requires increased power at the main rotor which, in turn, requires additional anti-torque force from the tail rotor. This is in contrast to fixed wing systems where the control inputs are less closely tied to each other and flight characteristics in different speed regimes are more closely related to each other.

Recently, fly-by-wire (FBW) systems have been introduced in rotorcraft to assist pilots in stably flying the rotorcraft and to reduce workload on the pilots. The FBW system may provide different control characteristics or responses for cyclic, pedal or collective control input in the different flight regimes, and may provide stability assistance or enhancement by decoupling physical flight characteristics so that a pilot is relieved from needing to compensate for some flight commands issued to the rotorcraft. FBW systems may be implemented in one or more flight control computers (FCCs) disposed between the pilot controls and flight control systems, providing corrections to flight controls that assist in operating the rotorcraft more efficiently or that put the rotorcraft into a stable flight mode while still allowing the pilot to override the FBW control inputs. The FBW systems in a rotorcraft may, for example, automatically adjust power output by the engine to match a collective control input, apply collective or power correction during a cyclic control input, provide automation of one or more flight control procedures provide for default or suggested control positioning, or the like.

Embodiments presented herein are directed to providing a maintenance planning system for a vehicle in connection with a future mission type. In particular, essential components of the vehicle are identified, and health assessments and health extrapolations are performed for the essential components. The health extrapolations are compiled into a risk profile for the vehicle. Options for maintenance actions are selected for some of the essential components, and the corresponding health extrapolations are revised or updated based on the selected maintenance options. The risk profile may also be adjusted based on the selected maintenance options and/or based on the revised health extrapolations. The adjusted risk profiles may then provide bases for comparison of multiple maintenance scenarios to facilitate decisions associated with choosing one or more preferred or optimal maintenance scenarios.

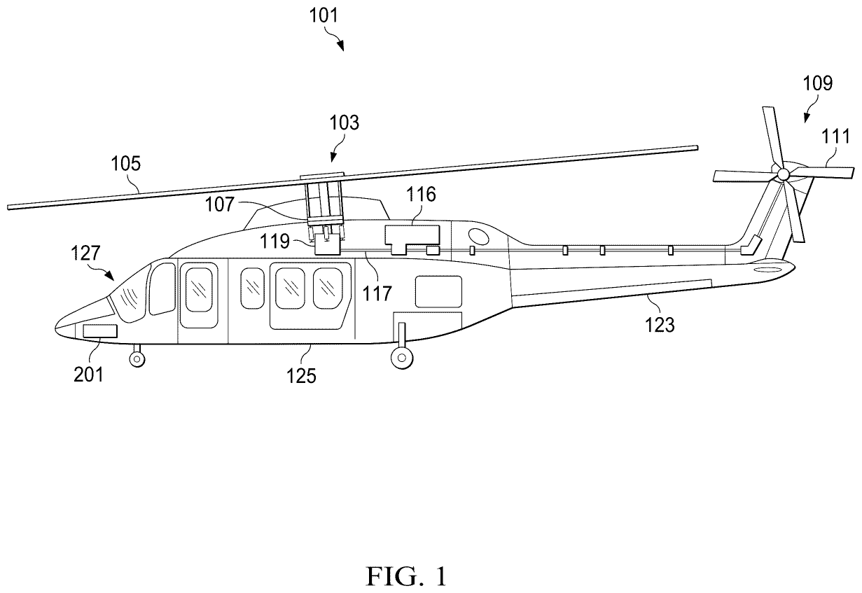

FIG. 1 is a schematic illustrating a rotorcraft 101, in accordance with some embodiments. The rotorcraft 101 has a main rotor system 103, which includes a plurality of main rotor blades 105. The pitch of each main rotor blade 105 may be controlled by a swashplate 107 in order to selectively control the attitude, altitude and movement of the rotorcraft 101. The swashplate 107 may be used to collectively and/or cyclically change the pitch of the main rotor blades 105. The rotorcraft 101 also has an anti-torque system, which may include a tail rotor 109, no-tail-rotor (NOTAR), or dual main rotor system. In rotorcraft with a tail rotor 109, the pitch of each tail rotor blade 111 is collectively changed in order to vary thrust of the anti-torque system, providing directional control of the rotorcraft 101. The pitch of the tail rotor blades 111 is changed by one or more tail rotor actuators. In some embodiments, the FBW system sends electrical signals to the tail rotor actuators or main rotor actuators to control flight of the rotorcraft.

Power is supplied to the main rotor system 103 and the anti-torque system by engines 116. There may be one or more engines 116, which may be controlled according to signals from the FBW system. The output of the engines 116 is provided to a driveshaft 117, which is mechanically and operatively coupled to the rotor system 103 and the anti-torque system through a main rotor transmission 119 and a tail rotor transmission, respectively.

The rotorcraft 101 further includes a fuselage 125 and tail section 123. The tail section 123 may have other flight control devices such as horizontal or vertical stabilizers, rudder, elevators, or other control or stabilizing surfaces that are used to control or stabilize flight of the rotorcraft 101. The fuselage 125 includes a cockpit 127, which includes displays, controls, and instruments. It should be appreciated that even though rotorcraft 101 is depicted as having certain illustrated features, the rotorcraft 101 may have a variety of implementation-specific configurations. For instance, in some embodiments, cockpit 127 is configured to accommodate a pilot or a pilot and co-pilot, as illustrated. It is also contemplated, however, that rotorcraft 101 may be operated remotely, in which case cockpit 127 could be configured as a fully functioning cockpit to accommodate a pilot (and possibly a co-pilot as well) to provide for greater flexibility of use, or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely. In yet other contemplated embodiments, rotorcraft 101 could be configured as an unmanned vehicle, in which case cockpit 127 could be eliminated entirely in order to save space and cost.

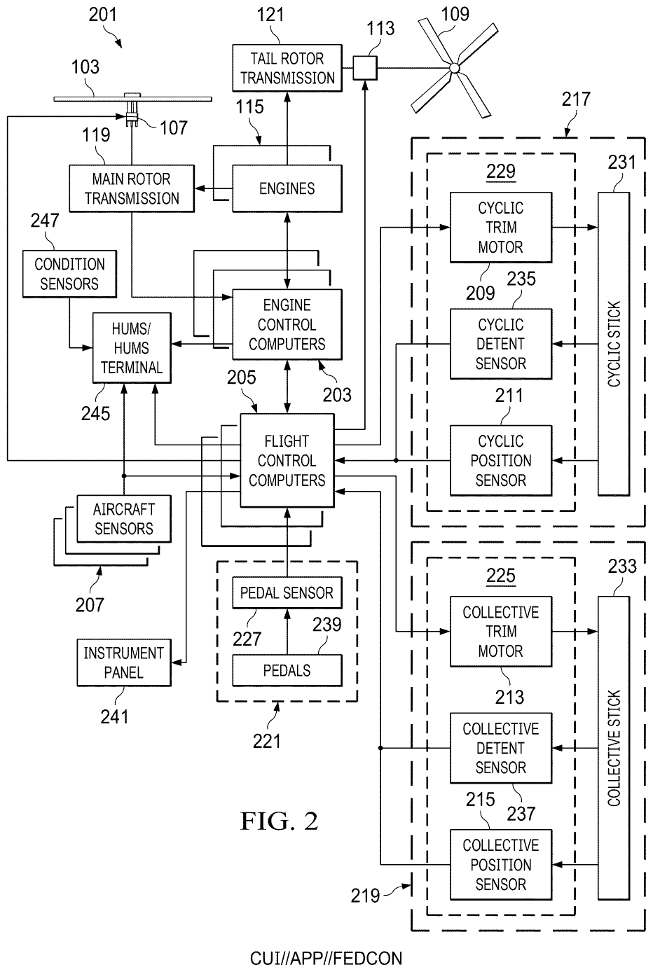

FIG. 2 is a block diagram illustrating a fly-by-wire control system for a rotorcraft, in accordance with some embodiments. A pilot may manipulate one or more pilot flight controls in order to control flight of the rotorcraft. The pilot flight controls may include manual controls such as a cyclic stick 231 in a cyclic control assembly 217, a collective stick 233 in a collective control assembly 219, and pedals 239 in a pedal control assembly 221. Inputs provided by the pilot to the pilot flight controls may be transmitted mechanically and/or electronically (e.g., via the FBW flight control system) to flight control devices by the flight control system 201. Flight control devices may represent devices operable to change the flight characteristics of the rotorcraft. Flight control devices on the rotorcraft may include mechanical and/or electrical systems operable to change the positions or angle of attack of the main rotor blades 105 and the tail rotor blades 111 or to change the power output of the engines 116, as examples. Flight control devices include systems such as the swashplate 107, tail rotor actuator 113, and systems operable to control the engines 116. The flight control system 201 may adjust the flight control devices independently of the flight crew in order to stabilize the rotorcraft, reduce workload of the flight crew, and the like. The flight control system 201 includes engine control computers (ECCUs) 203, flight control computers (FCCs) 205, and aircraft sensors 207, which collectively adjust the flight control devices and monitor the rotorcraft during operation.

The flight control system 201 has one or more FCCs 205. In some embodiments, multiple FCCs 205 are provided for redundancy. One or more modules within the FCCs 205 may be partially or wholly embodied as software and/or hardware for performing any functionality described herein. In embodiments where the flight control system 201 is a FBW flight control system, the FCCs 205 may analyze pilot inputs and dispatch corresponding commands to the ECCUs 203, the tail rotor actuator 113, and/or actuators for the swashplate 107. Further, the FCCs 205 are configured and receive input commands from the pilot controls through sensors associated with each of the pilot flight controls. The input commands are received by measuring the positions of the pilot controls. The FCCs 205 also control tactile cues to the pilot controls or display information in instruments on, for example, an instrument panel 241.

The ECCUs 203 control the engines 116. For example, the ECCUs 203 may vary the output power of the engines 116 to control the rotational speed of the main rotor blades or the tail rotor blades. The ECCUs 203 may control the output power of the engines 116 according to commands from the FCCs 205, or may do so based on feedback such as measured revolutions per minute (RPM) of the main rotor blades.

The cyclic control assembly 217 is connected to a cyclic trim assembly 229 having one or more cyclic position sensors 211, one or more cyclic detent sensors 235, and one or more cyclic actuators or cyclic trim motors 209. The cyclic position sensors 211 measure the position of the cyclic stick 231. In some embodiments, the cyclic stick 231 is a single control stick that moves along two axes and permits a pilot to control pitch, which is the vertical angle of the nose of the rotorcraft and roll, which is the side-to-side angle of the rotorcraft. In some embodiments, the cyclic control assembly 217 has separate cyclic position sensors 211 that measuring roll and pitch separately. The cyclic position sensors 211 for detecting roll and pitch generate roll and pitch signals, respectively, (sometimes referred to as cyclic longitude and cyclic latitude signals, respectively) which are sent to the FCCs 205, which controls the swashplate 107, engines 116, tail rotor 109 or related flight control devices.

The cyclic trim motors 209 are connected to the FCCs 205, and receive signals from the FCCs 205 to move the cyclic stick 231. In some embodiments, the FCCs 205 determine a suggested cyclic stick position for the cyclic stick 231 according to one or more of the collective stick position, the pedal position, the speed, altitude and attitude of the rotorcraft, the engine RPM, engine temperature, main rotor RPM, engine torque or other rotorcraft system conditions or flight conditions, or according to a predetermined function selected by the pilot. The suggested cyclic stick position is a position determined by the FCCs 205 to give a desired cyclic action. In some embodiments, the FCCs 205 send a suggested cyclic stick position signal indicating the suggested cyclic stick position to the cyclic trim motors 209. While the FCCs 205 may command the cyclic trim motors 209 to move the cyclic stick 231 to a particular position (which would in turn drive actuators associated with swashplate 107 accordingly), the cyclic position sensors 211 detect the actual position of the cyclic stick 231 that is set by the cyclic trim motors 206 or input by the pilot, allowing the pilot to override the suggested cyclic stick position. The cyclic trim motor 209 is connected to the cyclic stick 231 so that the pilot may move the cyclic stick 231 while the trim motor is driving the cyclic stick 231 to override the suggested cyclic stick position. Thus, in some embodiments, the FCCs 205 receive a signal from the cyclic position sensors 211 indicating the actual cyclic stick position, and do not rely on the suggested cyclic stick position to command the swashplate 107.

Similar to the cyclic control assembly 217, the collective control assembly 219 is connected to a collective trim assembly 225 having one or more collective position sensors 215, one or more collective detent sensors 237, and one or more collective actuators or collective trim motors 213. The collective position sensors 215 measure the position of a collective stick 233 in the collective control assembly 219. In some embodiments, the collective stick 233 is a single control stick that moves along a single axis or with a lever type action. A collective position sensor 215 detects the position of the collective stick 233 and sends a collective position signal to the FCCs 205, which controls engines 116, swashplate actuators, or related flight control devices according to the collective position signal to control the vertical movement of the rotorcraft. In some embodiments, the FCCs 205 may send a power command signal to the ECCUs 203 and a collective command signal to the main rotor or swashplate actuators so that the angle of attack of the main blades is raised or lowered collectively, and the engine power is set to provide the needed power to keep the main rotor RPM substantially constant.

The collective trim motor 213 is connected to the FCCs 205, and receives signals from the FCCs 205 to move the collective stick 233. Similar to the determination of the suggested cyclic stick position, in some embodiments, the FCCs 205 determine a suggested collective stick position for the collective stick 233 according to one or more of the cyclic stick position, the pedal position, the speed, altitude and attitude of the rotorcraft, the engine RPM, engine temperature, main rotor RPM, engine torque or other rotorcraft system conditions or flight conditions, or according to a predetermined function selected by the pilot. The FCCs 205 generate the suggested collective stick position and send a corresponding suggested collective stick signal to the collective trim motors 213 to move the collective stick 233 to a particular position. The collective position sensors 215 detect the actual position of the collective stick 233 that is set by the collective trim motor 213 or input by the pilot, allowing the pilot to override the suggested collective stick position.

The pedal control assembly 221 has one or more pedal sensors 227 that measure the position of pedals or other input elements in the pedal control assembly 221. In some embodiments, the pedal control assembly 221 is free of a trim motor or actuator, and may have a mechanical return element that centers the pedals when the pilot releases the pedals. In other embodiments, the pedal control assembly 221 has one or more trim motors that drive the pedal to a suggested pedal position according to a signal from the FCCs 205. The pedal sensor 227 detects the position of the pedals 239 and sends a pedal position signal to the FCCs 205, which controls the tail rotor 109 to cause the rotorcraft to yaw or rotate around a vertical axis.

The cyclic and collective trim motors 209 and 213 may drive the cyclic stick 231 and collective stick 233, respectively, to suggested positions. The cyclic and collective trim motors 209 and 213 may drive the cyclic stick 231 and collective stick 233, respectively, to suggested positions, but this movement capability may also be used to provide tactile cueing to a pilot.

Additionally, the cyclic control assembly 217, collective control assembly 219 and/or pedal control assembly 221 may each have one or more detent sensors that determine whether the pilot is handling a particular control device. The FCCs 205 may provide different default control or automated commands to one or more flight systems based on the detent status of a particular stick or pilot control.

The aircraft sensors 207 may be in communication with the FCCs 205, and a health and usage monitoring system (HUMS) 245. The aircraft sensors 207 may include sensors for monitoring operation of the rotorcraft, providing pilot data, providing condition data, or the like, and may include measuring a variety of rotorcraft systems, operating conditions, flight parameters, environmental conditions, and the like. For example, the aircraft sensors 207 may include sensors for gathering flight data, and may include sensors for measuring airspeed, altitude, attitude, position, orientation, temperature, airspeed, vertical speed, and the like. The aircraft sensors 207 may include sensors relying upon data or signals originating external to the rotorcraft, such as a global positioning system (GPS) sensor, a very high frequency (VHF) omnidirectional range sensor, Instrument Landing System (ILS), and the like. Additionally, one or more condition sensors 247 may be connected to the HUMS 245 and may include sensors for reading condition data such as vibration, device rotational speed, electrical operating characteristics, fluid flows, stress, operating temperatures, or the like.

The flight control system 201 may further include the HUMS 245 or a HUMS terminal. In some embodiments, the HUMS 245 collects data from flight control system 201 elements for storage and later download, analysis, or the like. The HUMS 245 may be used to gather data pertaining to the condition and health of certain components of the aircraft. This data may also be used to make assessments of an overall condition and health of the aircraft on an on-going basis. In accordance with some embodiments, these assessments may inform decisions with respect to planning maintenance on certain components of the aircraft.

For example, the HUMS 245 may be connected to one or more aircraft sensors 207, FCCs 205, ECCUs 203, standalone sensors, sensors integrated into the HUMS 245, condition sensors 247, or other system components, or a combination of components. The HUMS 245 may be separate from the FCCs 205, and may be implemented as a standalone system that communicates with, but that is operationally separate from, other elements of the flight control system 201. The HUMS 245 may be a terminal that stores raw sensor data from one or more aircraft components, and provides the raw sensor data to a server for interpretation and analysis. In some cases, the HUMS 245 may interpret raw sensor data to determine one or more condition indicators for a server or other system that analyzes or displays the data. The HUMS 245 may use data from the aircraft sensor 207 to determine one or more component performance characteristics, such as vibration. For example, the HUMS 245 may use a combination of vibration data and rotational speed data to generate synchronous vibration data or other transformed data types, which may be analyzed for indications of developing problems with specific components associated with the vibration data.

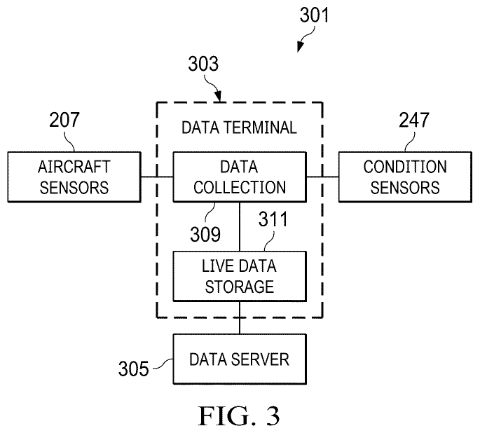

FIG. 3 is a block diagram for a health and usage monitoring system (HUMS) for the gathering, processing, and analysis of condition indicators, in accordance with some embodiments. The HUMS 301 may include a data terminal 303 that is connected to one or more condition sensors 247, aircraft sensors 207, and a data server 305. The aircraft sensor 207 may be sensors that gather flight data such as airspeed, altitude, attitude, position, orientation, temperature, airspeed, vertical speed, and the like. The condition sensors 247, as discussed above, and may take sensor readings and generate one or more sensor signals such as electrical signals, data elements, or the like, that indicate condition data or one or more operational parameters. For example, a condition sensor 247 may be a vibration sensor near an engine, gear set or transmission that detects vibrations from the local components. In another example, the condition sensor 247 may be a voltage sensor or current detector that detects the voltage or current drawn by an electrical component such as a pump or a motor. In yet another example, the condition sensor 247 may be a pressure or flow sensor that detects the pressure of a hydraulic line or fuel line, the flow rate of a fluid such as fuel, coolant, oil hydraulic fluid, or the like. The data generated by the sensors may be condition data, and may be used directly as CIs by the HUMS 301 for operational monitoring, or may be used to generate one or more associated CIs. For example, an electrical sensor may monitor a current drawn by an electrical pump to infer operating speed, RPM or flow rate condition indicators, and one or more condition indicators may be used as CI data for adjustment and subsequent use in operational monitoring. In another example, a vibration sensor may send raw sensor data such as accelerometer vibration data to the HUMS 301, and the HUMS 301 may determine a CI according to the root mean square (RMS) of the accelerator vibration data. In yet another example, the HUMS 301 may determine the magnitude of a vibration at a particular frequency from frequency spectrum data using, for example, a Fourier analysis or other technique.

The data terminal 303 may be a computer or other device that receives the sensor signals and stores data from the sensor signals locally for later analysis. In some embodiments, one or more of the HUMS terminal, the FCCs or ECCUs are data terminals 303. The data terminal 303 has a data collection element 309 that is a data handling element such as a processor, data collection circuit or device, or the like. In some embodiments, the data terminal 303 is a HUMS terminal that is a centralized device or standalone device that collects raw sensor data and/or smart sensor data (e.g., data sets, alerts, trends, etc.) from the condition sensors 247 and that generates condition indicators from the raw sensor data, processed data (e.g., smart sensor data), or from a sensor signal, or that collects condition indicators from the condition sensors 247. In some embodiments, the data collection element 309 also includes a communications circuit that receives the sensor signal from the condition sensors 247 and provides the sensor signal to the data collection element 309, which saves a condition indicator based on the sensor signal in live data storage 311.

The data terminal 303 collects a series of data points related to condition indicators for conditions that the data server 305 monitors. In some embodiments, the data server 305 receives raw sensor data or condition data from the data terminal 303 or from the sensors 307 associated with the data terminal 303, and performs analysis to determine condition indicators from the condition data or raw sensor data. In other embodiments, the data terminal 303 performs the analysis and sends processed data, such as a condition indicator, data sample, or the like, to the data server 305.

In some embodiments, the data terminal 303 stores the sensor signal, or condition data from a sensor signal, as the condition indicator in the live data storage 311, and in other embodiments, the data terminal 303 processes the raw sensor data or condition data to generate a condition indicator based on, or according to, the raw sensor data or condition data before storing the condition indicator. The data terminal 303 may actively query a sensor 307, may receive a signal from a sensor 307, or may sample a signal from a sensor 307 to acquire raw sensor data or a sensor signal. The data terminal 303 may acquire the data signal at a particular time in a flight or in response to one or more operational parameters meeting a predetermined set of criteria. Thus, each condition indicator set may be associated with an operating condition or operating range, and may be referenced by an operational parameter associated with the operating condition. The data terminal 303 may acquire condition data, by sampling a continuous or live sensor signal, or querying a sensor, when the data terminal 303 detects that flight conditions or operational parameters meet one or more criteria or that the vehicle is operating within a particular operating range. For example, the data terminal 303 may be an FCC, and may determine that the engines are in a high speed cruise state based on the throttle and collective settings, and may acquire a condition data indicating, for example, vibrations of one or more components of an engine, transmission, gear train, or the like, or for fuel flow, power generation, transmission torque, or the like. In another example, the data terminal 303 may determine that the rotorcraft is in a hover, in forward flight, or in another flight state, and may acquire the condition data during the flight state.

In some embodiments, the data terminal may continuously monitor a particular sensor, condition data, or the like, and may associate measured data, condition data, raw sensor data, CIs, or the like, with a predetermined operating range or capture window associated with a specific operational parameter, operating range, such as a range of operational parameters, or other parameter. For example, a data terminal 303 may monitor a signal from a vibration sensor on a rotorcraft transmission, and may save data received while the vehicle is operating within a predetermined operating range or operational parameter (e.g., airspeed between 100-130 kts, torque within a particular range, etc.). Alternatively, the data terminal 303 may save all received data, or may save samples of data received from a sensor, and may associate relevant data points with operational parameters associated with the relevant operating conditions or operating range (e.g., airspeed was 122 kts at the time that the sensor data was acquired).

Condition indicator sets (CI sets) may be formed from measurements or condition indicators determined in relation to similar operational parameters to provide consistent data. For example, a first condition indicator set may include condition indicators for a main rotor transmission gear during high speed cruise across multiple flights, while a second condition indicator set may include condition indicators for the same main rotor transmission gear during hover across multiple flights. Similarly, a condition indicator set may be formed from data or condition indicators associated with the same, or similar operational parameters or operating range. Thus, a transmission vibration data set may include data readings taken by a sensor when the vehicle operates at a particular airspeed or range of airspeed, or while the engine torque is within a certain range, or the like.

The data terminal 303 may store data such as the condition data, a sample of data, condition indicators, and other sensor data or relevant identifying information in the live data storage 311. In some embodiments, the CI data may be tagged with a date, time, and operational parameter information when stored in the live data storage 311 for later transmission to the data server 305. Additionally, the data terminal 303 may store the data with information associating the CI data with a particular operating range or operational parameter.

The data server 305 aggregates data from one or more data terminals 303. The data server 305 collects data in one or more condition indicator sets for aggregation and analysis, and may provide a report, alerts or other information for individual condition indicators data sets. The data server 305 stores condition indicators, data set information, and the like.

Each system component may include one or more processors and one or more computer readable medium storing computer code thereon. References to computer-readable storage medium, computer program product, tangibly embodied computer program, or the like, or a controller, monitor, engine monitor, monitoring system, computer, processor, or the like should be understood to encompass not only computers having different architectures such as single or multi-processor architectures and sequential (Von Neumann) or parallel architectures but also specialized circuits such as field-programmable gate arrays (FPGAs), application specific integrated circuits (ASICs), signal processing devices, and other devices. References to computer program, instructions, code, or the like, should be understood to encompass software for a programmable processor or firmware such as, for example, the programmable content of a hardware device whether instructions for a processor, or configuration settings for a fixed-function device, gate array or programmable logic device, or the like.

For example, each system component may have at least one processor and at least one memory, such as a non-transitory computer readable medium, and may include computer program code, that is configured to, with the at least one processor, provide the data processing and communication. The memory may be a single component or it may be implemented as one or more separate components some or all of which may be integrated or removable and may provide permanent, semi-permanent, dynamic, or cached storage.

The one or more processors are configured to read from and write to the at least one memory. The processor may also comprise an output interface via which data or commands are output by the processor and an input interface via which data or commands are input to the processor. The memory stores a computer program including computer program instructions that control the operation of the engine monitoring, and possibly the overall system, when loaded into the processor. The computer program instructions provide the logic and routines that enable the apparatus to perform the data processing and communication and implement the digital backbone based communication systems. The processor, by reading the memory, is able to load and execute the computer program. The computer program or programs may arrive at the apparatus via any suitable delivery mechanism. The delivery mechanism may be, for example, a computer-readable storage medium, a computer program product, a memory device, a record medium such as a compact disc read on only memory (CD-ROM), digital versatile disc (DVD), portable memory such as a memory stick or hard drive, or the like, an article of manufacture that tangibly embodies the computer program. In some embodiments, the delivery mechanism may be a signal configured to reliably transfer the computer program over the air or via an electrical connection.

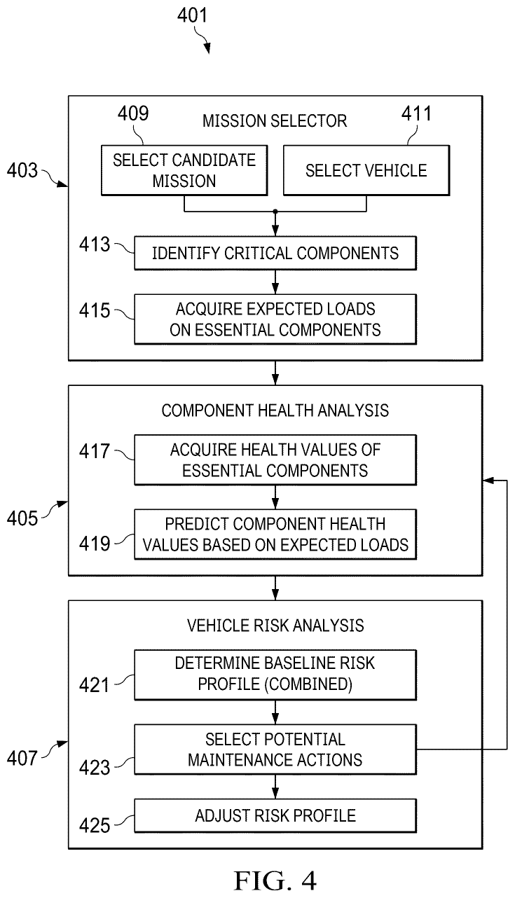

FIG. 4 is a block diagram illustrating a maintenance planning system (MPS) 401 to schedule maintenance for components of a vehicle between flights over the course of a future mission type, in accordance with some embodiments. As such, the MPS 401 may also be referred to as a maintenance scheduling process. The MPS 401 (e.g., as a system or method) may utilize or be performed by a system having a data terminal and data server, and may be embodied in a software program stored on a non-transitory computer-readable storage medium that is executed by a processor of the data terminal and a processor of the data server.

As discussed in greater detail below, the MPS 401 may include determining an overall risk level for the vehicle to require unscheduled maintenance. In addition, the MPS 401 may consider various maintenance scenarios of maintenance actions on some components of the vehicle based on desired objectives (e.g., maintain operation at sufficiently low risk levels, minimize maintenance hours, etc.) and mission type parameters. Further, the MPS 401 may allow users to adjust maintenance actions and time as which to perform the maintenance actions to account for desired objectives, mission type parameters, or other factors that may influence the decision.

The MPS 401 may comprise multiple subsystems (or sub-processes), such as a mission type selector subsystem 403, a component health analysis subsystem 405, and a vehicle risk analysis subsystem 407. As discussed in greater detail below, each of these subsystems may be broken down into smaller steps. Although the MPS 401 may follow the order discussed and illustrated, some steps may be performed in parallel or in different orders, as appropriate.

Referring to block 403, a mission type selection is performed to acquire mission-related parameters which will be used by the MPS. In accordance with some embodiments, a candidate mission or a set of missions (e.g., future or hypothetical missions) and a vehicle (e.g., a rotorcraft) may be selected or identified (see blocks 409 and 411, respectively). In some embodiments, the candidate mission may be an on-going mission type for the selected vehicle, wherein the candidate mission effectively includes the remaining portions of the on-going mission type. Certain components of the vehicle are then identified as being essential to the completion of the candidate mission (see block 413). In addition, loads on those essential components are predicted based on key parameters of the candidate mission (see block 415). For example, a mission type profile of the candidate mission may inform operational parameters of the vehicle throughout the candidate mission which may then inform rates of usage (e.g., loads) on the essential components throughout the candidate mission. The loads on the essential components may be helpful with the component health analysis subsystem 405 as discussed below.

Referring to block 405, a health analysis is performed for each essential component to predict their respective health values throughout the candidate mission. In accordance with some embodiments, historical health values of the essential components are acquired (see block 417). In addition, trend lines of the respective historical health values may be used to estimate current health values of the essential components. Health values of the essential components over the course of the candidate mission may then be predicted by extrapolating from the current health values based on the expected loads of the candidate mission as identified through the mission type selection subsystem 403 (see block 419).

Referring to block 407, vehicle risk analyses are performed to compare maintenance options and choose a maintenance schedule for the candidate mission. In accordance with some embodiments, a baseline risk profile which may be generated by combining the extrapolated health values for each of the essential components (see block 421). Maintenance schedule options are then selected, such as choosing which component(s) on which to perform maintenance during the candidate mission and choosing at which point(s) in the candidate mission to perform each maintenance (see block 423). The first risk profile (e.g., the baseline risk profile) is then adjusted based on how the maintenance would affect the extrapolated health values of the corresponding components to form an adjusted risk profile (see block 425). In some embodiments, generating the adjusted risk profile may utilize the component health analysis subsystem 405 to update the predicted component health values for the essential components selected for maintenance. Note that maintenance schedule options and adjusting the risk profile may be repeated multiple times to gather and compare a subset of the possible maintenance schedules.

It should be appreciated that the MPS 401 may be used to prepare or adjust a maintenance schedule during an on-going mission type. Similarly, the MPS 401 may be used to prepare a maintenance schedule across more than one mission type.

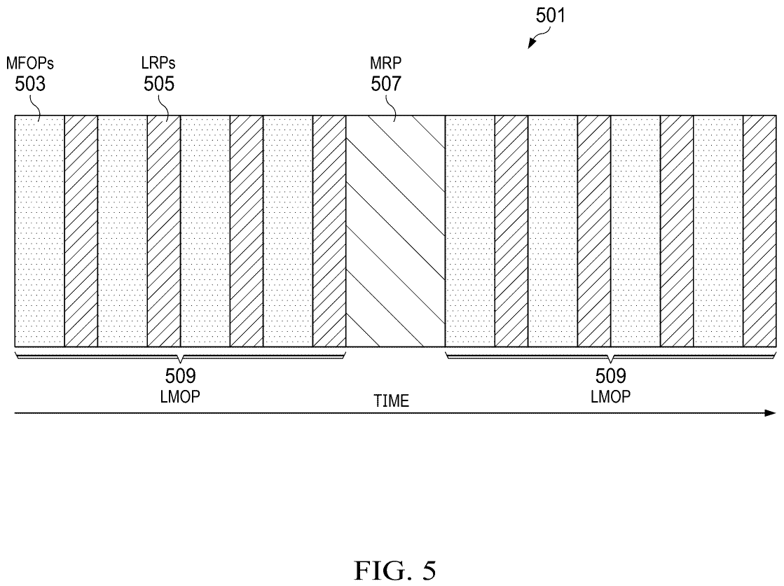

FIG. 5 is a diagram illustrating typical rotorcraft usage periods, in accordance with some embodiments. For example, maintenance free operating periods (MFOPs) 503 represent periods of time in which the rotorcraft may operate for one or a plurality of flights without maintenance. Limited recovery periods (LRPs) 505 separate sequential MFOPs 503 in order to perform low to medium level maintenance on the rotorcraft. After several iterations of MFOPs 503 and LRPs 505, a maintenance recovery period (MRP) 507 represents a period of time in which a more thorough (e.g., comprehensive) maintenance is performed on the rotorcraft. Another set of iterations of MFOPs 503 and LRPs 505 may follow the MRP 507. Each set of these iterations may be referred to as a limited maintenance operating period (LMOP) 509. In some embodiments, a mission type may comprise some or all of an LMOP 509 between two MRPs 507 (e.g., a subset of the MFOPs 503 and LRPs 505 between the two MRPs 507). In addition, a mission type may include one or more MRPs 507 as well as some or all of the adjacent LMOPs 509.

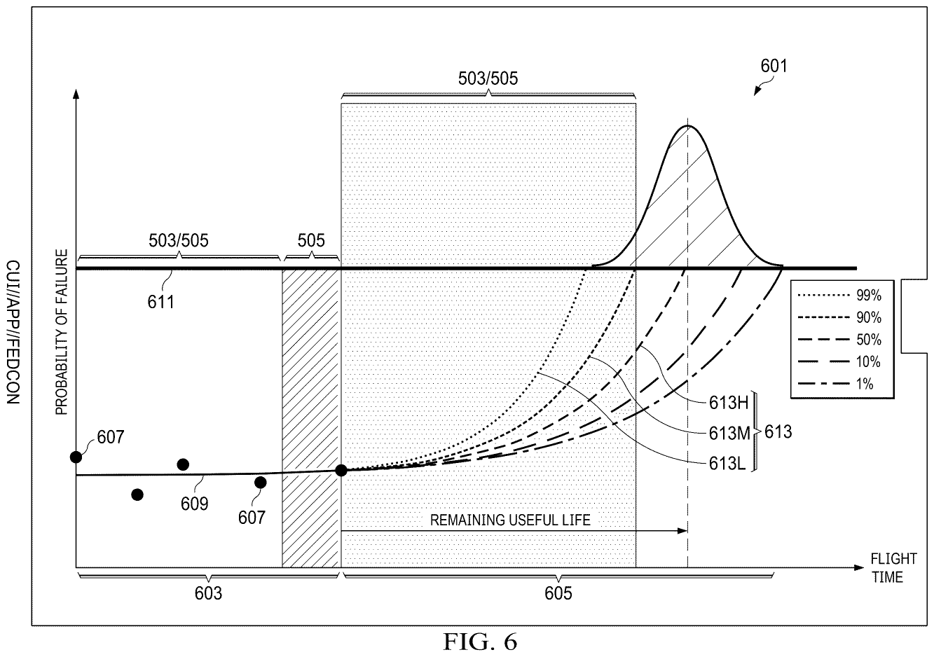

FIG. 6 is a component health value graph 601 providing historic health values and predicted health values of a component of a vehicle (e.g., a rotorcraft) over the course of past and future usage. As illustrated, the graph 601 may be broken up into a historical data section 603 and a future prediction section 605. For example, the historical data section 603 includes historical health values 607 of the particular component and a trend line 609 fitted to the historical health values. The future prediction section 605 includes an extrapolation of the trend line 609 to show predicted health values for the component over future usage.

Referring to the historical data section 603 of the graph 601, health values 607 are plotted over the course of previous flight time. The health values 607 may be based on measurements related to condition indicator data acquired during rotorcraft flights. As such, the health values 607 are correlated with a probability of failure, such that lower health values 607 (e.g., proximal to the horizontal axis) indicate a lower probability of failure and higher health values 607 (e.g., proximal to a failure threshold line 611) indicate a higher probability of failure. The failure threshold line 611 represents a hypothetical health value at which the component would be expected to fail. The trend line 609 may be fitted to the health values 607 using any suitable method, such as filtering (e.g., Kalman filters, particle filters, etc.) and/or a fit or regression. In some embodiments, the trend line 609 may be a linear regression, quadratic regression, exponential regression, or the like. The regression may be fit to the health values 607 using a least squares regression, robust regression, or any suitable methodology. As illustrated, the trend line 609 may have a positive slope of increasing health values 607 which correlate to an increasing probability of failure. Note that the historical data section 603 may include one or more MFOPs 503 and intervening LRPs 505. As illustrated, in some embodiments, a most recent health value 607 may have been acquired at the end of the most recent LRP 505.

Referring to the future prediction section 605 of the graph 601, the trend line 607 may be extrapolated to provide a health value extrapolation line 613. As illustrated, the extrapolation 613 may take the form of a probability distribution, such that each associated risk level of the probability distribution may be represented by a unique extrapolation line 613. Note that a risk level of the probability distribution inversely correlates to a probability of success distribution, as discussed in greater detail below. The point at which the health value extrapolation line 613 intersects with the failure threshold line 611 indicates the point in time at which the component would be expected to fail. As illustrated, the risk level has a meaningful effect on expectations for the remaining useful life of the component. For example, a low risk analysis would utilize a point of the probability distribution indicating a relatively low remaining useful life of the component, and the opposite would be the case for a high risk analysis.

For the sake of discussion of the illustrated embodiment, a low risk extrapolation line 613L may represent 1% risk (or 99% probability of success), a medium risk extrapolation line 613M may represent 10% risk (or 90% probability of success), and a high risk extrapolation line 613H may represent 50% risk (or 50% probability of success). For example, there is a 1% risk that the component will have a lower remaining useful life (or earlier point of failure) than indicated by the low risk extrapolation line 613L. In other words, there is 99% probability that the component will meet or exceed the remaining useful life (or the point of failure) indicated by the low risk extrapolation line 613L. In addition, there is a 10% risk that the component will have a lower remaining useful life (or earlier point of failure) than indicated by the medium risk extrapolation line 613M (e.g., a 90% probability of meeting or exceeding those metrics). Further, there is a 50% risk that the component will have a lower remaining useful life (or earlier point of failure) than indicated by the high risk extrapolation line 613H (e.g., a 50% probability of meeting or exceeding those metrics).

Note that in various embodiments discussed below in connection with other figures, a low risk level may indicate a 1% risk (e.g., a 99% probability of success), a medium risk level may indicate a 5% risk (e.g., a 95% probability of success), and a high risk level may indicate a 10% risk (e.g., a 90% probability of success). In particular, when high technology vehicles are being used for critical mission types, stricter categorizations of risk levels may be useful because a 50% risk, for example, may not be acceptable in the contexts discussed herein. However, any suitable risk level may be utilized as appropriate for the particular necessity.

In various embodiments, the historical data section 603 of the graph 601 may be determined based on condition indicator data from, for example, a sensor in the vehicle. The sensor may measure phenomena like vibration (or observe features of vibration) or acceleration on bearings. The future prediction section 605 of the graph 601 may be a statistical distribution in a simple case, such as representing a mean time between failures (MTBF) which might be hourly to provide a risk of failure over time in flight hours. A more complex case may include other factors, such as environment, time at particularly extreme temperatures, time at high vibration or other loads, time in continuous flight, time in high stress environments, time in high loading environments (e.g., high torque which could result in more bearing failures). However, any suitable methodologies may be used.

Moreover, sensors on the vehicle generate data that may be downloaded to a maintenance analysis system (e.g., the maintenance planning system). Although thresholds in trend detection may be utilized to identify changes in a trend, embodiments herein make risk predictions. As such, the risk predictions may be generated as distributions of risk over time for multiple components. For example, a system for analytical distribution may calculate a cumulative function based on mean and standard deviation. In addition, the risk may be modeled as a Gaussian distribution, wherein Bayesian analysis may be used to generate a bell curve model. For example, these methodologies may be particularly useful for those essential components whose risk may be predicted using a system reliability model, wherein multiple elements are either used in series or parallel to determine overall system reliability. Note that similar methodologies may be used to generate vehicle risk profiles (e.g., compilations of the health extrapolations) as described in connection with block 407 of FIG. 4 and in greater detail below.

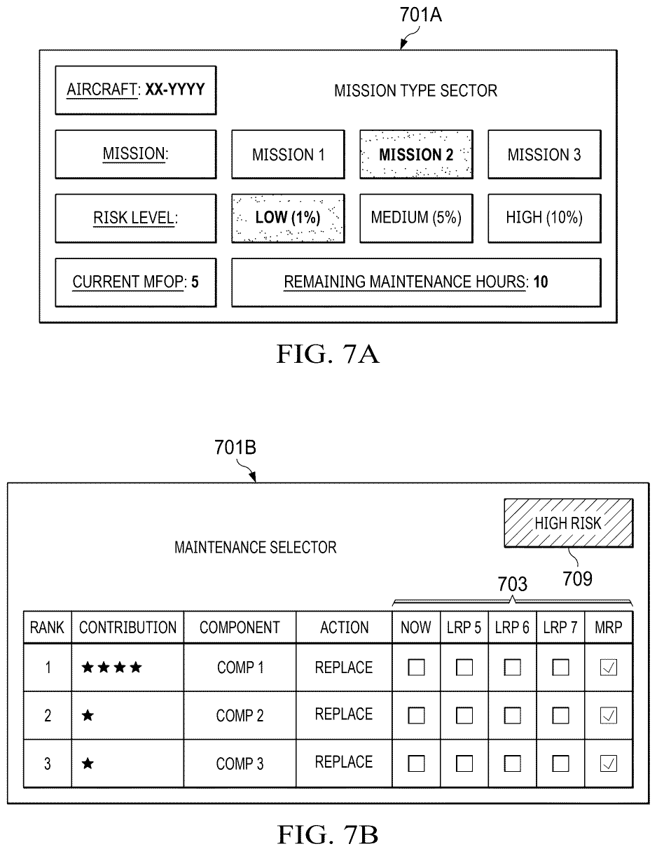

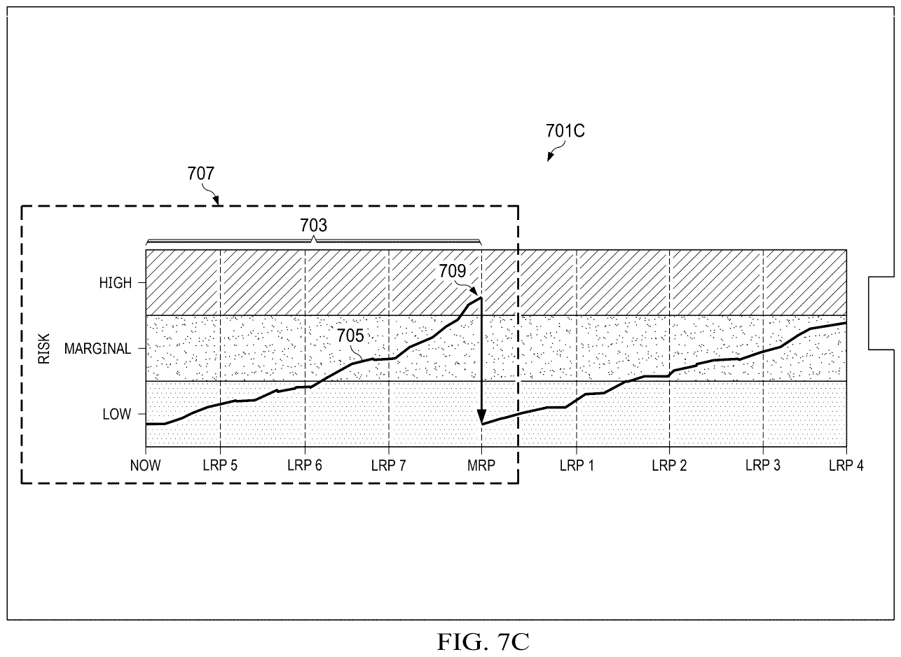

FIGS. 7A-9 are interface features illustrating intermediate uses of a maintenance planning system, in accordance with some embodiments. Note that some of the illustrated features are representative of the MPS and may not necessarily be part of a display. For example, some of these features may be calculations that run in the background or data that is stored without being displayed, wherein such calculations and data are still used in the MPS. In addition, the illustrated displays are exemplary and any suitable displays or modifications of the illustrated displays may be utilized. FIGS. 7A-7C illustrate exemplary embodiments for determining a baseline risk profile for a vehicle undergoing a selected mission type, making hypothetical selections of maintenance actions of essential components, and adjusting the baseline risk profile. Various inputs, outputs, or other parameters that may be useful in a maintenance planning system (MPS) (see, e.g., FIG. 4) are depicted. For example, FIGS. 7A-7C may represent exemplary user interface features which facilitate some parts of the MPS. However, it should be appreciated that other suitable layouts may be utilized. As discussed in greater detail below, certain inputs relating to a mission type, a vehicle, and an acceptable risk level may be used to identify essential components of the vehicle for the mission type, maintenance options for the essential components, and a baseline risk profile for the vehicle (e.g., without selecting additional maintenance actions).

FIG. 7A illustrates exemplary inputs and parameters relating to a mission type selection 701A, in accordance with some embodiments. In the illustrated embodiment, the vehicle (e.g., aircraft or rotorcraft) is provided with a generic identifier of XX-YYYY, Mission 2 is selected, and a low risk level of 1% is selected. The vehicle may be selected at this step or already be known. In addition, the Current MFOP 503 is displayed as 5, which means that Mission 2 with vehicle XX-YYY has completed four MFOPs within the current LMOP. As such, the vehicle is currently at the fourth LRP before starting the fifth MFOP. Note that Mission 2 may be beginning at this stage of the current LMOP, or Mission 2 may be an on-going mission type that is partially complete. Further, the Remaining Maintenance Hours may be an input by the user or an output based on the vehicle and/or the mission type. For example, 10 remaining maintenance hours are displayed, which means that up to 10 more hours of maintenance may be scheduled in a maintenance scenario for the current LMOP (e.g., before the MRP).

FIG. 7B illustrates a maintenance selector 701B, which provides a list of essential components and maintenance selections 703 for the selected mission type, in accordance with some embodiments. In the illustrated embodiment, the essential components of the selected mission type are provided with generic identifiers of Comp 1, Comp 2, and Comp 3. Although three component identifiers are listed, it should be appreciated that maintenance actions for any suitable number of essential components may be assessed. For example, the essential components may include a particular hydraulic pump, a tail rotor gearbox, and a pitch link rod-end, respectively. In addition, the available maintenance actions are listed as Replace (e.g., replacing the component), which may include any other suitable maintenance actions such as Repair, Inspect, or other suitable maintenance actions for those particular components.

In addition, maintenance selections 703 are provided as an array of boxes following the essential components. The maintenance selections 703 represent the possible points in time during a relevant period (e.g., a relevant time period) to perform the selected actions, such as through the current LMOP (and, optionally, through the upcoming MRP). In embodiments in which the selected mission type continues beyond the upcoming MRP and into some or all of the next LMOP, the maintenance selector 701B may either include maintenance selections 703 for only the current LMOP (and the upcoming MRP) or for the current LMOP and the next LMOP (and the upcoming intervening MRP). Initially, only the MRP boxes among the maintenance selections 703 are checked, which may represent a standard protocol to perform all maintenance actions on the essential components during the MRP. In the illustrated embodiment, all of the essential components receive maintenance at the upcoming MRP regardless of whether earlier maintenance actions are selected. This exemplary standard protocol is represented in the corresponding risk profile as described in greater detail immediately below. However, it should be appreciated that the risk profile may be adjusted to account for different protocols.

The maintenance selector 701B also includes a maximum risk level 709, which indicates the highest risk level that the vehicle would be expected to reach at any point during the relevant period based on the selected maintenance selections 703. As discussed in greater detail below, the maximum risk level 709 is visually represented in a scenario profile, such as the baseline scenario profile 705 of FIG. 7C.

FIG. 7C illustrates a baseline scenario 701C for the vehicle by tracking a predicted baseline risk profile 705 over the course of various stages during a selected period 707 (e.g., time period or portions of LMOP and MRP), in accordance with some embodiments. Note that the selected time period 707 may include a partial mission type, a full mission type, or multiple mission types (partial or full). For example, each MFOP (e.g., between consecutive LRPs or between consecutive LRP and MRP) within the selected period 707 may depict a unique mission type or be part of a same mission type across the selected time period 707. As discussed above, the baseline risk profile 705 represents a combination or amalgamation of the health extrapolations of the essential components (see FIG. 6) to indicate risks of failure for the vehicle through the selected time period. In some embodiments, the risk of failure increases over the course of Mission 2 until maintenance is performed on any essential components.

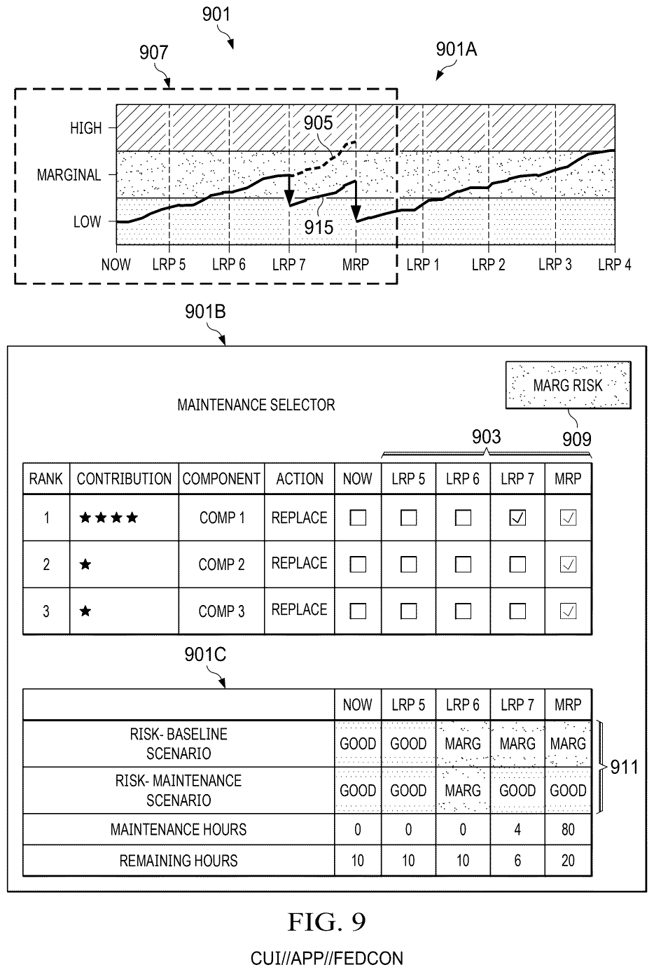

In accordance with various embodiments, the baseline risk profile 705 of the baseline scenario 701C depicts an overall risk of failure for the vehicle based on an amalgamation of health value graphs 601 (e.g., health extrapolations showing probabilities of failure) for the essential components. For example, a simple embodiment may include one essential component as contributing to the overall risk of failure of a vehicle during a particular mission type (and selected risk level). As such, the vehicle's baseline risk profile 705 would be substantially identical (or at least directly correlative) to the health value graph 601 for that essential component. However, in many embodiments, a plurality of essential components are identified for a particular vehicle and mission type. In addition, these essential components have differing contribution levels to the overall vehicle's baseline risk profile 705. In the illustrated embodiment, Component 1 has a substantially greater contribution than each of Component 2 and Component 3. Moreover, Component 2 and Component 3 have substantially same contributions as one another. As such, a maintenance action performed on Component 1 (see, e.g., FIG. 9) would be expected to cause a greater reduction to the baseline risk profile 705 as compared to a maintenance action performed on either Component 2 or Component 3.

As noted previously, and as provided in the illustrated embodiment, a selected mission type (e.g., Mission 2) may include a remainder of the current LMOP and a portion of the next LMOP (as well as the intervening MRP). In addition, the selected period 707 is indicated by a dashed box to identify the portion of Mission 2 for which the maintenance selector 701B is providing maintenance selections (e.g., based on the maintenance selections 703). In some embodiments (not specifically illustrated), the maintenance selector 701B may provide maintenance options through the completion of Mission 2. For the sake of simplicity, it may sometimes be preferable to make the maintenance selections 703 separately for each LMOP (e.g., the current LMOP before the MRP and the next LMOP after the MRP) because the exemplary standard protocol may include full maintenance of the essential components during the intervening MRP. However, any suitable grouping of the LMOPs (or underlying LRPs) may be assessed with respect to the selections 703 of the maintenance options.

In the illustrated embodiment, the vehicle is at the Low risk level currently (e.g., Now). In addition, the vehicle is predicted to remain in the Low risk level through LRP 6. However, the vehicle is predicted to reach the Marginal risk level before LRP 7 and the High risk level (e.g., the maximum risk level 709) before reaching the MRP. Maintenance during the MRP brings the vehicle back down to the Low risk level. Further, the baseline risk profile 705 shows that the risk of failure for the vehicle is predicted to increase again during the next LMOP after the MRP.

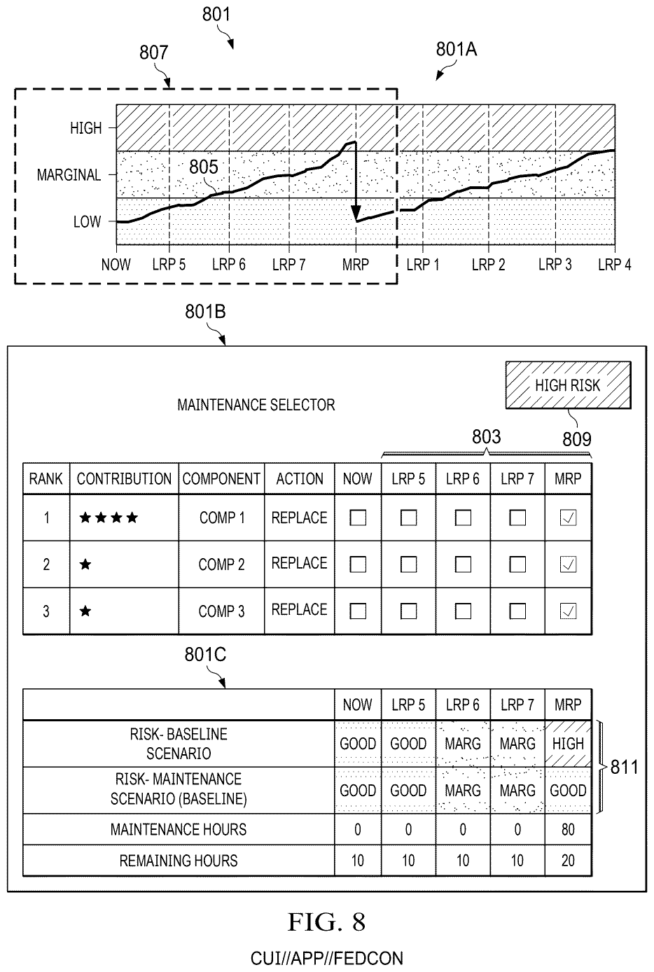

Referring again to FIG. 7B, in some embodiments, an indicator may show the maximum risk level 709 that the vehicle is predicted to reach based on the current maintenance selections 703. In the illustrated embodiment, only maintenance actions during the MRP are selected for the baseline scenario, and the expected loads on the essential components during use will cause the predicted risk level to reach High sometime during the last MFOP before the MRP. The indicator may show the risk level as Marginal or Low depending on the current risk profile for the vehicle. In some embodiments (not specifically illustrated in FIGS. 7A-7C), each potential maintenance stage (e.g., Now, LRP 5, LRP 6, LRP 7, MRP) may have a corresponding indicator to show the highest risk level reached before and up to each respective stage. Indeed, similar types of indicators are reflected in other aspects of the MPS described below (see, e.g., FIGS. 8, 9, and 10A-10D).

FIG. 8 illustrates a baseline scenario 801A comprising a baseline risk profile 805 (similarly as FIG. 7C), a maintenance selector 801B with the associated maintenance selections 803 (similarly as FIG. 7B), and a simplified baseline scenario 801C with additional indicators 811, in accordance with various embodiments. Note that elements illustrated in FIG. 8 may be analogous with similarly numbered elements from FIGS. 7A-7C, however, the elements of FIG. 8 start with the numeral “8.” Similarly as illustrated in FIG. 7B, only the MRP currently shows maintenance actions being performed on the essential components. For the sake of simplicity, a mission type selection (similarly as FIG. 7A) is omitted from FIG. 8.

In accordance with some embodiments, the simplified baseline scenario 801C is a chart depicting risk indicators 811 at each stage of the maintenance selections 803 (e.g., Now, LRP 5, LRP 6, LRP 7, MRP) which reflect the highest risk level that the vehicle is predicted to reach during each preceding MFOP up through the corresponding LRP/MRP stage. In particular, each stage includes a risk indicator at the point of reaching that stage (e.g., the risk level for the baseline scenario without maintenance) and a risk indicator after completion of any selected maintenance during that stage (e.g., the risk level for the selected maintenance scenario). In the illustrated embodiment, each of these indicator couplets is the same until reaching the MRP.

As further illustrated, the chart for the simplified baseline scenario 801C further displays expected Maintenance Hours associated with the maintenance selections 803 and Remaining Hours available for selection of other maintenance actions during the relevant period. For example, the Remaining Maintenance Hours for maintenance during the LRP may be capped due to mission type requirements, resource limitations, protocol, policy, and/or other suitable reasons. In the illustrated embodiment, there are 10 maintenance hours remaining for the remainder of the current LRP (e.g., from Now up until the MRP), and the Remaining Maintenance Hours remains the same for each of those stages because no maintenance actions have been selected. In addition, the MRP includes 80 maintenance hours (e.g., including maintenance on all of the essential components and other MRP-standard maintenance) and 20 remaining maintenance hours.

FIG. 9 illustrates a maintenance scenario 901A with an adjusted risk profile 915 based on maintenance selections 903 in comparison with the baseline risk profile 905, in accordance with some embodiments. For example, a maintenance action may be selected by choosing an essential component and selecting the stage (e.g., Now, LRP 5, LRP 6, LRP 7) at which to perform the action associated with that essential component. The maintenance action would improve the health value of that essential component at the chosen stage. As a result, the predicted health value of that essential component that was used to generate the baseline risk profile 905 for the vehicle may no longer be applicable because the amount of risk contributed by that essential component would decrease after performing maintenance on that essential component. It should be appreciated that performing the maintenance action(s) requires maintenance time (e.g., indicated in hours), which is not unlimited and may increase the overall duration of the LRP. After making the maintenance action selection(s), the adjusted risk profile 915 must be generated, therefore, to reflect how the risk profile for the overall vehicle changes (e.g., decreases) with the selected maintenance action. Note that multiple maintenance selections 903 may be selected before generating the adjusted risk profile 915.

As discussed above, the risk profiles 905, 915 reflect an overall risk of failure for the vehicle based on an amalgamation of health value graphs 601 (e.g., probabilities of failure) for the essential components. In the simplest embodiments with only one essential component, the vehicle risk profile would be substantially identical (or directly correlative) to the health value graph 601 of that essential component. For example, a full repair or replacement of the essential component would be expected to bring the risk profile down to the lowest risk of failure. It should be appreciated that the lowered risk of failure would likely be above zero because a used or brand new vehicle with brand new components would still have a non-negligible risk of failure. However, in most embodiments, a plurality of essential components are identified for a particular vehicle and mission type(s). In addition, the essential components have differing contribution levels to the overall vehicle risk profile. In the illustrated embodiment, Component 1 has a substantially greater contribution than each of Component 2 and Component 3.

In some embodiments, the adjusted risk profile 915 may be generated similarly as but independently from the baseline risk profile 905, albeit with different inputs based on the maintenance selections 903. In other embodiments, the maintenance selections 903 may be applied to the baseline risk profile 905 to calculate how portions of the baseline risk profile 905 would be adjusted to shift (e.g., shift downward) based on those maintenance selections 903. In yet other embodiments, a combination of these approaches may be utilized to generate the adjusted risk profile 915. For example, both approaches may be performed and compared or combined to calculate a probability of success for the resulting adjusted risk profile 915.

As noted above, some embodiments include generating the adjusted risk profile 915 by revisiting certain parts of the MPS as described above in connection with FIG. 4. In particular, predicted health values (e.g., probabilities of failure) will change for the essential component upon which the maintenance would be performed (see FIG. 6). For example, at the point of maintenance, the health value of the essential component may be reset to a lowest risk level for that essential component (e.g., a replacement with a new or unused version of the essential component) at the stage at which the maintenance action is to be performed (e.g., the corresponding maintenance selection 903). In some cases, the health value for the essential component may be lowered only partially when the type of maintenance action would not fully reset the health value (e.g., for a repair of the essential component, or for a supplementing or supporting of the essential component with another component).

Next, the adjusted risk profile 915 is generated based on the updated predicted health values for the essential component selected for maintenance. Similarly as discussed above in connection with block 421 of FIG. 4, the adjusted risk profile 915 may combine the respective predicted health values for each of the essential components, which includes the updated predicted health values for the essential component and corresponding maintenance selection(s) 903. The adjusted risk profile 915 is illustrated with a continuous line which includes downward arrows indicating decreases in risk level at the times of the maintenance actions (e.g., at LRP 7 and MRP). In addition, the baseline risk profile 905 is illustrated with a dashed line to provide a visual comparison between the particular maintenance scenario and the baseline scenario.

As further illustrated, in some embodiments, the slopes of the adjusted risk profile 915 between LRP 7 and MRP may differ from the slopes of the baseline risk profile 905 between LRP 7 and MRP. These differences reflect the real world phenomenon that changes in the health values of the essential component receiving the maintenance do not necessarily have a direct or linear effect on the risk profile for the vehicle. For example, the slopes of the adjusted risk profile 915 could be generally lower than the corresponding slopes of the baseline risk profile 905 because an essential component that is closer to failure may contribute a disproportionately greater risk to the vehicle than if that essential component were at a much lower risk level (e.g., being new or at a reset health value). In addition, the degree of this disproportionality may vary based on the relevant operational parameters or loads of a flight, such as whether the essential component is especially critical or under especially higher loads during takeoff, landing, acceleration (e.g., speed and/or direction), or the like.

In the illustrated embodiment, note that the maintenance selection 903 at LRP 7 lowers the risk level to Low, but the adjusted risk profile 915 does not necessarily decrease to a risk level as low as the current risk level (e.g., the risk level at Now). In comparison, the maintenance actions during the MRP could potentially lower the risk level to substantially the same as or lower than the current risk level. Notably, although the risk level of the adjusted risk profile 915 between LRP 7 and MRP still reaches the Marginal risk level, the risk level no longer reaches the High risk level. As a result, the risk indicator 909 (e.g., signaling the highest risk level that the vehicle is predicted to reach based on the current maintenance selections 903) changes from High to Marginal. In some embodiments, this may be considered a sufficient reduction in overall risk to render the current maintenance selections 903 as representing a satisfactory maintenance scenario.

As also noted above, some embodiments include generating the adjusted risk profile 915 by applying the one or more selected maintenance actions to the baseline risk profile 905. In particular, a weighting of the contribution of that essential component may be used as a factor or multiplier in calculating how much the baseline risk profile 905 may shift downward to generate the adjusted risk profile 915. For example, among all of the essential components (e.g., three essential components), the essential component receiving maintenance may be approximated as contributing to a certain percentage (e.g., 50%) of the risk profile. Adjusting the risk profile may include first calculating how much the risk level would be expected to decrease after performing maintenance on all of the essential components at once (e.g., during a single stage). The risk profile is then shifted by an amount proportionate to the contribution percentage of the essential component that is selected for maintenance. As an example, if maintenance of all essential components would shift the risk profile downward by one arbitrary unit, then the adjusted risk profile for performing maintenance on the selected essential component (e.g., having a contribution percentage of 50%) would reflect shifting the baseline risk profile 905 downward by one-half of the arbitrary unit.

Note that among the immediately foregoing embodiments, the adjusted risk profile 915 is generated by essentially shifting a relevant portion of the baseline risk profile 905 downward. For example, the portion of the risk profile between LRP 7 and the MRP is shifted downward by a calculated amount as described above. Accordingly, it should be appreciated that the slopes of this portion of the adjusted risk profile 915 may be the same as or proportionate with the corresponding slopes of the baseline risk profile 905. However, any suitable methodologies may be utilized to adjust the risk profile to reflect maintenance actions performed on some or all of the essential components.

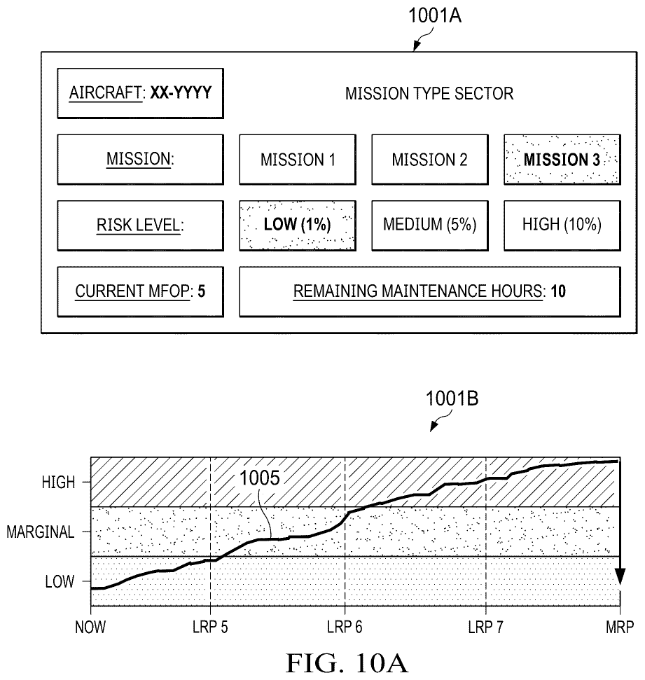

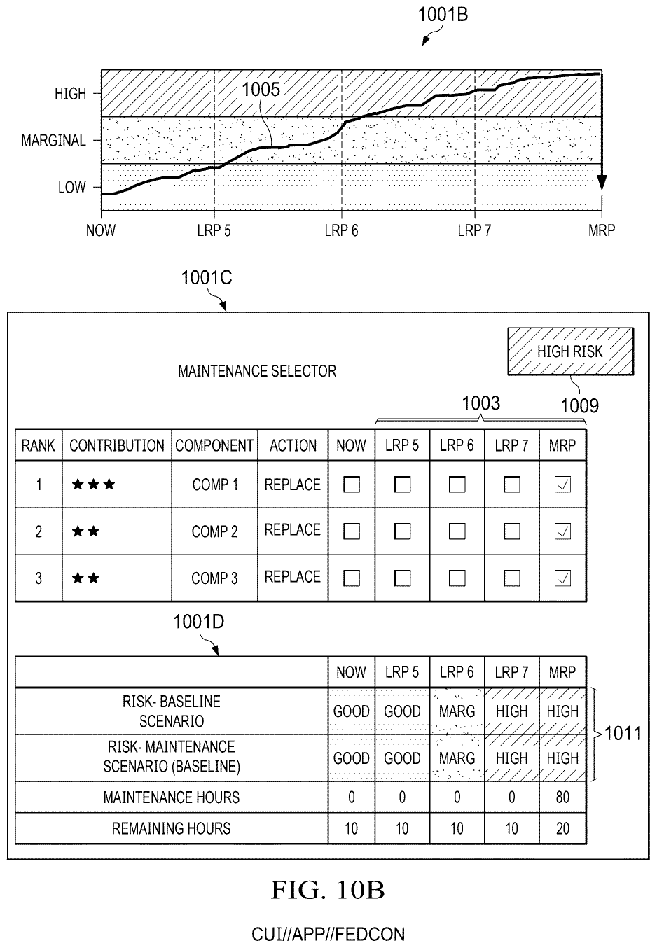

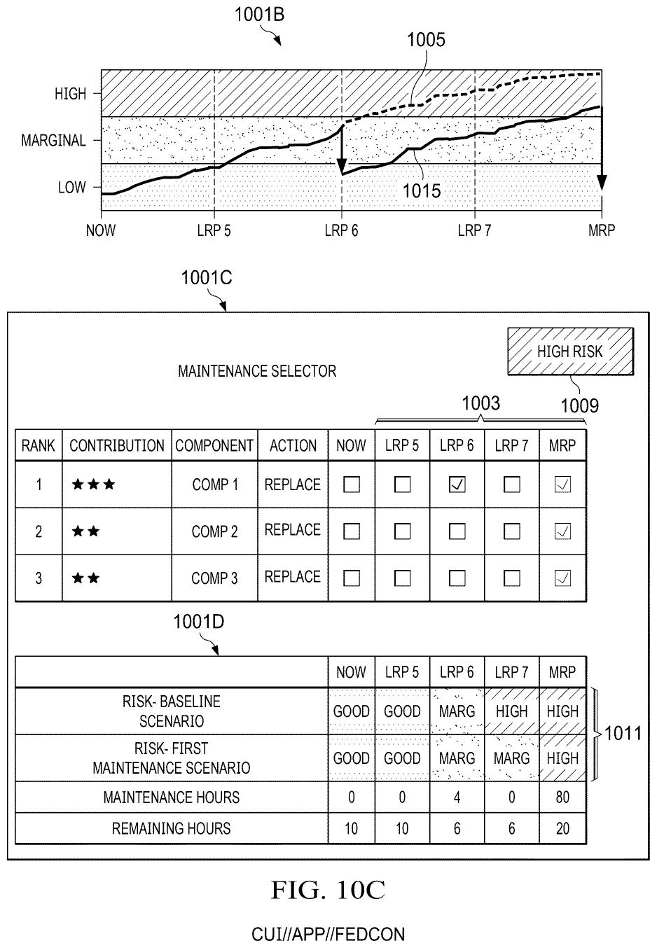

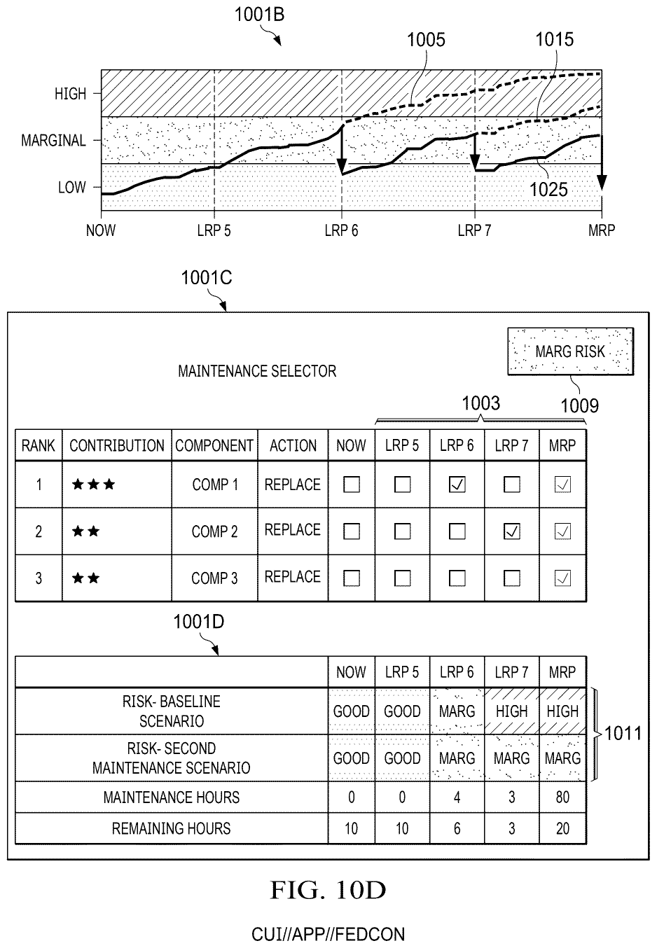

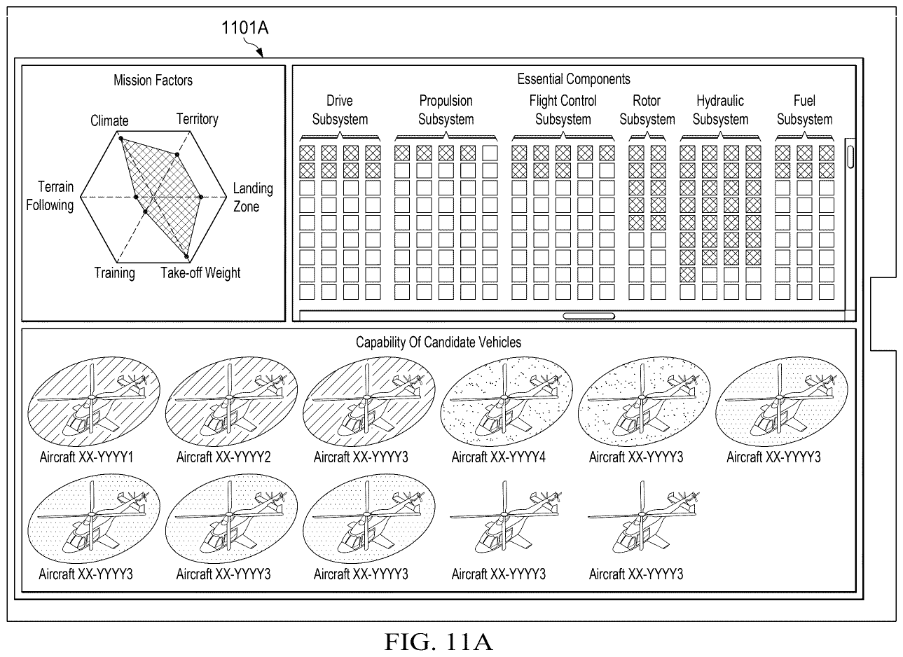

FIGS. 10A-10D illustrate exemplary embodiments for acquiring a baseline risk profile 1005 for a vehicle undergoing a selected mission type, making hypothetical maintenance selections 1003 of maintenance actions on essential components, and adjusting and readjusting risk profiles 1015, 1025 based on the maintenance selections 1003. As noted above in connection with other discussions, some of the illustrated features are representative of the MPS and may not necessarily be part of a display. For example, some of these features may be calculations that run in the background or data that is stored without being displayed, wherein such calculations and data are still used in the MPS. In addition, the illustrated displays are exemplary and any suitable displays or modifications of the illustrated displays may be utilized.

FIG. 10A provides the mission type selector 1001A and corresponding inputs and parameters (similarly as FIG. 7A) along with a baseline scenario 1001B with a baseline risk profile 1005 (similarly as FIGS. 7C and 8). FIG. 10B provides the baseline risk profile 1001B, the maintenance selector 1001C displaying a first maintenance scenario (e.g., a baseline maintenance scenario) with maintenance selections 1003 for the MRP alone, and intermediate risk indicators. FIG. 10C provides an adjusted risk profile in relation to the maintenance selector displaying a second maintenance scenario with an additional maintenance action selected for a first component, the overall risk indicator, and the intermediate risk indicators. FIG. 10D provides an adjusted risk profile in relation to the maintenance selector displaying a third maintenance scenario with two additional maintenance actions selected for the first component and a second component, the overall risk indicator 1009, and the intervening risk indicators 1011.

Referring to FIG. 10A, the mission type selector 1001A may display various inputs and parameters, and the baseline scenario 1001B shows the baseline risk profile 1005 which is generated, at least in part, based on the inputs and parameters from the mission type selector 1001A. In the illustrated embodiments, Mission 3 with a low risk level (e.g., 1%) has been selected. In addition, the vehicle (e.g., an aircraft identified generally as XX-YYYY) is currently at the fourth LRP of the current LMOP before starting the fifth MFOP. Note that Mission 3 may be beginning at this stage of the current LMOP, or Mission 3 may be an on-going mission type that is partially complete. Further, the Remaining Maintenance Hours is displayed as 10, which means that up to 10 more hours of maintenance may be scheduled during the current LMOP (e.g., before the MRP). Moreover, Mission 3 may be complete by the MRP or continue through the next LMOP (which is omitted from the baseline risk profile 1001B).

In the illustrated example, the baseline risk profile 1001B shows the risk level for the vehicle starting in the Low region, increasing into the Marginal region, and further increasing into the High region. The risk level decreases again to the Low region during the MRP when maintenance actions are performed for all essential components.

Referring to FIG. 10B, the baseline risk profile 1001B is displayed in relation to the maintenance selector 1001C and a simplified baseline scenario 1001D (similarly as FIGS. 8 and 9). As noted above, the baseline scenario 1001B may reflect maintenance of all essential components at the upcoming MRP (e.g., a standard protocol) without other maintenance options selected during the current LMOP leading up to the MRP. As such, in the illustrated embodiment, the risk level is currently (e.g., Now) at Low and is expected to remain at Low (albeit higher) through LRP 5. In addition, the risk level is expected to increase to Marginal by LRP 6 and further increase to High by LRP 7. Accordingly, the overall risk indicator 1009 shows a High risk level.

Referring to FIG. 10C, an adjusted risk scenario 1001B is displayed in relation to the maintenance selector 1001C and simplified maintenance scenario 1001D, which depict an adjusted maintenance scenario (e.g., a first adjusted maintenance scenario) and the corresponding risk indicators 1009, 1011. In particular, the adjusted risk scenario 1001B depicts an adjusted risk profile 1015 as well as the baseline risk profile 1005. The adjusted maintenance scenario may include the standard maintenance at the MRP as well as an additional maintenance option selected. For example, a first component (e.g., Component 1) is selected for maintenance (e.g., replacement) during LRP 6. As a result, in the illustrated embodiment, the risk level of the adjusted risk profile 1015 still reaches Marginal by LRP 6, however, the risk level decreases to Low after performing maintenance on Component 1 at LRP 6 (e.g., before starting the seventh MFOP). In addition, the risk level increases again during the seventh MFOP to reach a risk level of Marginal before LRP 7, and the risk level is expected to reach High shortly before the upcoming MRP. Accordingly, the overall risk indicator continues to show a High risk level.

Referring to FIG. 10D, another adjusted risk scenario 1001B is displayed in relation to the maintenance selector 1001C and simplified maintenance scenario 1001D, which depict a another adjusted maintenance scenario (e.g., a second adjusted maintenance scenario) and the corresponding risk indicators 1009, 1011. In particular, the adjusted risk scenario 1001B now depicts a second adjusted risk profile 1025 as well as the baseline risk profile 1005 and the first adjusted risk profile 1015. The second adjusted maintenance scenario may include the standard maintenance at the MRP as well as two additional maintenance options selected. For example, the first component (e.g., Component 1) is selected for maintenance during LRP 6, and a second component (e.g., Component 2) is selected for maintenance during LRP 7. As a result, in the illustrated embodiment, the risk level of the second adjusted risk profile 1025 still increases to Marginal by LRP 6, decreases to Low after maintenance at LRP 6, increases to Marginal again by LRP 7, decreases to Low after maintenance at LRP 7, and increases to Marginal by the upcoming MRP. Accordingly, the overall risk indicator shows a Marginal risk because the risk level never reaches High during the current LMOP and before reaching the upcoming MRP.

The processes referenced in connection with FIGS. 10A-10D may be viewed as a trial and error process for identifying an acceptable maintenance scenario or a subset of acceptable maintenance scenarios to choose from. It should be appreciated that there are a definite number of maintenance scenarios based on each possible combination of maintenance actions at each stage of the relevant LMOP. As a result, after providing certain key inputs and parameters relating to mission type selection, the MPS may generate the baseline risk profile 1005 while also generating adjusted risk profiles 1015, 1025 (and more) for all of the possible maintenance scenarios. The MPS may organize and display the results based on certain characteristics, such as the overall risk level, a total maintenance hours (e.g., a sum of the maintenance hours across all stages), a total number of maintenance actions (e.g., a count of the maintenance actions across all stages), or any other specified characteristic.

Moreover, multiple maintenance scenarios from the results may be selected for the MPS to display the baseline risk profile 1005 with each of the corresponding adjusted risk profiles 1015, 1025 on a single graph (or a desired subset of the adjusted risk profiles). A user could then apply a visual assessment to assist in choosing between otherwise comparable maintenance scenarios. For example, knowledge relating to one of the LRPs coinciding with a time when maintenance resources are expected to be especially limited may encourage any maintenance scenarios include little or no maintenance actions during that LRP. In some embodiments, the MPS may be integrated with other maintenance schedules in order to facilitate this type of assessment and decision-making.

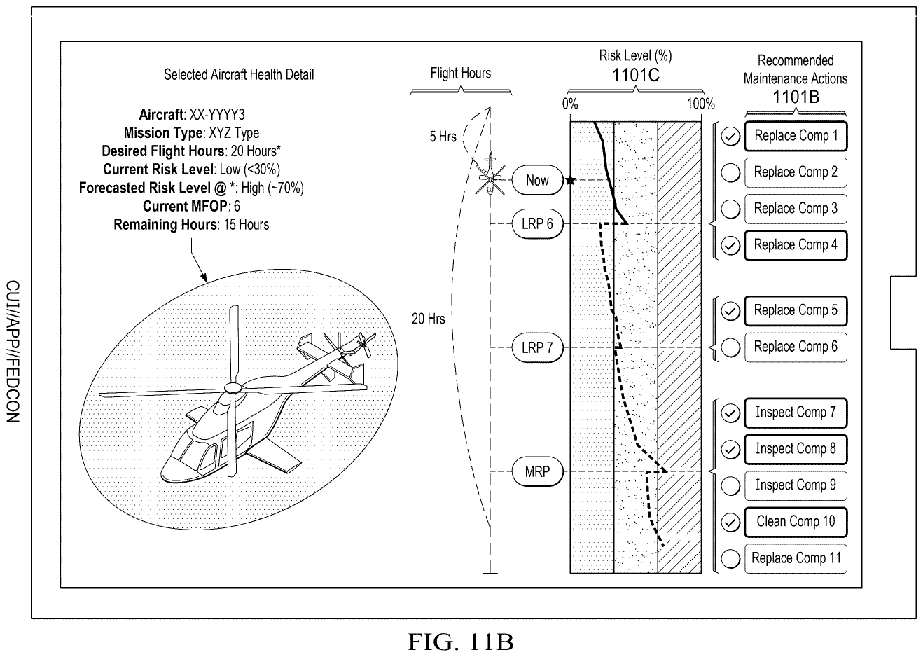

FIGS. 11A and 11B illustrate additional interface features of an MPS, in accordance with some embodiments. For example, FIG. 11A provides a mission type selector 1101A to facilitate selection or adjustments to a mission type, a vehicle, and essential components of the vehicle. FIG. 11B provides a maintenance selector 1101B and a corresponding risk profile 1101C to adjust maintenance scenarios and generate adjusted risk profiles.

Referring to FIG. 11A, the mission type selection 1101A may include selecting a candidate mission by inputting values of various factors or facets of the candidate mission. In some embodiments, the factors may include one or more of a climate factor, a territory factor, a landing zone factor, a take-off weight factor, a training factor, and a terrain following factor. However, any combinations of these factors as well as other suitable factors may be included.

In some embodiments, the MPS translates these mission factor inputs into a list of the most essential components for a vehicle undergoing the candidate mission (e.g., a mission type with the specified factor inputs). In addition, the list of essential components may be categorized by vehicle subsystem. In other embodiments, all relevant components of the vehicle are already listed, and the user may select and deselect the listed components to choose essential components for the MPS. In either case, a weighting of the contribution of the essential component may be provided to assist the selection/deselection process.

As further illustrated, the mission type selection 1101A may include selecting a vehicle from a list of available vehicles. In some embodiments, the list of available vehicles includes a broad assessment of each vehicle's overall health. For example, the health of each listed vehicle may be based on the health values of the essential components. In accordance with various embodiments, a user may select a vehicle for the MPS to display health assessments of the essential components.

Note that the mission type selection 1101A may include any appropriate combination of features described and illustrated with respect to FIG. 11A. In addition, the mission type selection 1101A may include any appropriate combination of these features with other features described above in connection with previous embodiments.

Referring to FIG. 11B, the maintenance selector 1101B may include selecting maintenance options for a variety of maintenance scenarios for the MPS to generate and output the associated risk profiles 1101C. These steps may be performed similarly as described above in connection with previous embodiments. For example, each maintenance scenario may be displayed with a visual depiction in addition to (or rather than) being displayed in a chart as provided in previous embodiments.

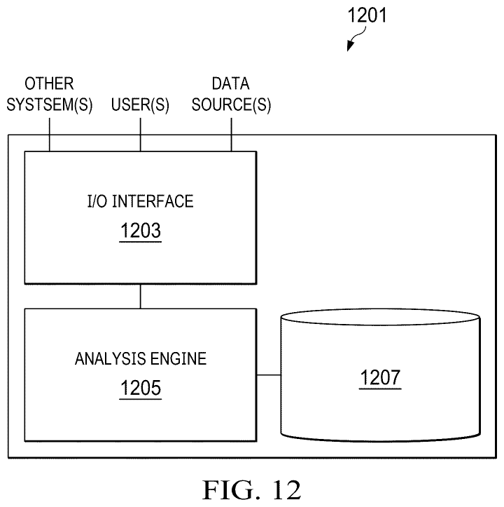

FIG. 12 is a diagram illustrating a computer system 1201 that may be used to implement a system, data terminal, or data server according to some embodiments. The computer system 1201 can include an input/output (I/O) interface 1203, an analysis engine 1205, and a database 1207. Alternative embodiments can combine or distribute the I/O interface 1203, the analysis engine 1205, and the database 1207, as desired. Embodiments of the computer system 1001 may include one or more computers that include one or more processors and memories configured for performing tasks described herein. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers include a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multipurpose machines, for example computer workstations, that are suitable for also performing other tasks.

The I/O interface 1203 can provide a communication link between external users, systems, and data sources and components of the computer system 1201. The I/O interface 1203 can be configured for allowing one or more users to input information to the computer system 1201 via any known input device. Examples can include a keyboard, mouse, touch screen, and/or any other desired input device. The I/O interface 1203 can be configured for allowing one or more users to receive information output from the computer system 1201 via any known output device. Examples can include a display monitor, a printer, cockpit display, and/or any other desired output device. The I/O interface 1203 can be configured for allowing other systems to communicate with the computer system 1201. For example, the I/O interface 1203 can allow one or more remote computer(s) to access information, input information, and/or remotely instruct the computer system 1201 to perform one or more of the tasks described herein. The I/O interface 1203 can be configured for allowing communication with one or more remote data sources. For example, the I/O interface 1203 can allow one or more remote data source(s) to access information, input information, and/or remotely instruct the computer system 1001 to perform one or more of the tasks described herein.

The database 1207 provides persistent data storage for the computer system 1201. Although the term “database” is primarily used, a memory or other suitable data storage arrangement may provide the functionality of the database 1207. In alternative embodiments, the database 1207 can be integral to or separate from the computer system 1001 and can operate on one or more computers. The database 1207 preferably provides non-volatile data storage for any information suitable to support the operation of the flight control system 201 and the methods 401, 501, 601, 701, 801, and/or 901 (as applicable), including various types of data discussed further herein. The analysis engine 1205 can include various combinations of one or more processors, memories, and software components.

An embodiment method includes selecting a candidate mission, the candidate mission includes a mission type profile, selecting a candidate vehicle to undergo the candidate mission, identifying one or more components of the candidate vehicle, the one or more components being associated with the candidate vehicle in relation to the candidate mission, providing a current condition value for the candidate vehicle based on condition data of the one or more components, generating one or more health models for the one or more components, combining the one or more health models into a baseline risk profile for the vehicle, providing a first alert signal to indicate prognostication of whether the baseline risk profile passes above a risk threshold, selecting a first component of the one or more components for a first maintenance procedure, generating, based in part on the first maintenance procedure, an adjusted risk profile for the candidate vehicle, and providing a second alert signal to indicate prognostication of whether the adjusted risk profile passes above the risk threshold.

In some embodiments, generating the one or more health models for the one or more components is based at least in part on flight test data for a same type of the candidate vehicle. In some embodiments, selecting the first maintenance procedure includes selecting a period of time during the candidate mission to perform the first maintenance procedure, and wherein the period of time during the candidate mission is free of other maintenance procedures. In some embodiments, the method further includes selecting a risk level for the candidate mission. In some embodiments, combining the health models into the baseline risk profile is based in part on the risk level for the candidate mission. In some embodiments, the method further includes if the second alert signal is provided, selecting a second component of the one or more components for a second maintenance procedure, generating, based in part on the second maintenance procedure, an additional adjusted risk profile, and providing a third alert signal if any portion of the additional adjusted risk profile is above the risk threshold. In some embodiments, the method further includes making a comparison of the baseline risk profile, the adjusted risk profile, and the additional adjusted risk profile, and deciding on performances of the first maintenance procedure and the second maintenance procedure based on the comparison. In some embodiments, the mission type profile of the candidate mission includes one or more of a climate factor, a territory factor, a landing zone factor, a take-off weight factor, a training factor, and a terrain following factor.

An embodiment maintenance planner includes one or more processors, and at least one non-transitory computer readable memory connected to the one or more processors and including computer program code, wherein the at least one non-transitory computer readable memory and the computer program code are configured, with the one or more processors, the computer program code including instructions for receiving a vehicle selection, receiving a mission type selection for the vehicle selection, acquiring mission type data relating to the vehicle selection and the mission type selection, the mission type data includes a list of a plurality of essential components of the vehicle selection, the plurality of essential components includes a first essential component and a second essential component, generating a first health value extrapolation of the first essential component and a second health value extrapolation of the second essential component, generating a first risk profile for the vehicle selection and the mission type selection, providing a first signal indicating a first highest risk of the first risk profile, receiving a maintenance action selection for the first essential component, generating a second risk profile based on the maintenance action selection, and providing a second signal indicating a second highest risk of the second risk profile, the second highest risk being lesser than the first highest risk.

In some embodiments, the computer program code further includes instructions for generating a third health value extrapolation based on the maintenance action selection. In some embodiments, generating the first risk profile includes consolidating the first health value extrapolation and the second health value extrapolation, and wherein generating the second risk profile includes consolidating the third health value extrapolation and the second health value extrapolation. In some embodiments, the mission type selection includes a selected mission type and a risk level for the selected mission type. In some embodiments, the mission type data includes a mission type schedule, wherein the mission type schedule includes alternating usage periods and maintenance periods, and wherein the maintenance action selection includes a selected maintenance period. In some embodiments, generating the second risk profile includes shifting a portion of the first risk profile.

An embodiment maintenance planning system includes a vehicle profile of a vehicle, the vehicle profile includes a maintenance outline for the vehicle, the maintenance outline includes usage periods and maintenance periods, a mission type profile of a mission type, the mission type profile includes a timeline of the mission type, the timeline overlapping with a portion of the maintenance outline, and a maintenance planner, the maintenance planner includes a mission type selection step for selecting at least one of the vehicle or the mission type profile, a component health analysis step for generating health value extrapolations for essential components of the vehicle, a maintenance selection step for selecting maintenance actions to be performed during the maintenance periods, and a vehicle risk analysis step for generating a risk profile based on the health value extrapolations and the maintenance actions.

In some embodiments, the mission type selection step of the maintenance planner identifies the essential components based on the vehicle and the mission type profile. In some embodiments, the maintenance periods include a plurality of limited maintenance periods and a comprehensive maintenance period. In some embodiments, selecting the maintenance actions includes selecting the maintenance actions to be performed during the limited maintenance periods. In some embodiments, generating the health value extrapolations includes updating the health value extrapolations based on the selecting maintenance actions to be performed. In some embodiments, generating the risk profile includes adjusting a first risk profile to generate a second risk profile.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
selecting a candidate mission, the candidate mission comprising a mission type profile;
selecting a candidate vehicle to undergo the candidate mission;
identifying one or more components of the candidate vehicle, the one or more components being associated with the candidate vehicle in relation to the candidate mission;
providing a current condition value for the candidate vehicle based on condition data of the one or more components;
generating one or more health models for the one or more components;
combining the one or more health models into a baseline risk profile for the vehicle;
providing a first alert signal to indicate prognostication of whether the baseline risk profile passes above a risk threshold;
selecting a first component of the one or more components for a first maintenance procedure;
generating, based in part on the first maintenance procedure, an adjusted risk profile for the candidate vehicle; and
providing a second alert signal to indicate prognostication of whether the adjusted risk profile passes above the risk threshold.

2. The method of claim 1, wherein generating the one or more health models for the one or more components is based at least in part on flight test data for a same type of the candidate vehicle.

3. The method of claim 1, wherein selecting the first maintenance procedure comprises selecting a period of time during the candidate mission to perform the first maintenance procedure, and wherein the period of time during the candidate mission is free of other maintenance procedures.

4. The method of claim 1, further comprising selecting a risk level for the candidate mission.

5. The method of claim 4, wherein combining the health models into the baseline risk profile is based in part on the risk level for the candidate mission.

6. The method of claim 1, further comprising, if the second alert signal is provided:
selecting a second component of the one or more components for a second maintenance procedure;
generating, based in part on the second maintenance procedure, an additional adjusted risk profile; and
providing a third alert signal if any portion of the additional adjusted risk profile is above the risk threshold.

7. The method of claim 6, further comprising:
making a comparison of the baseline risk profile, the adjusted risk profile, and the additional adjusted risk profile; and
deciding on performances of the first maintenance procedure and the second maintenance procedure based on the comparison.

8. The method of claim 1, wherein the mission type profile of the candidate mission comprises one or more of a climate factor, a territory factor, a landing zone factor, a take-off weight factor, a training factor, and a terrain following factor.

9. A maintenance planner, comprising:
one or more processors; and
at least one non-transitory computer readable memory connected to the one or more processors and including computer program code, wherein the at least one non-transitory computer readable memory and the computer program code are configured, with the one or more processors, the computer program code including instructions for:
receiving a vehicle selection;
receiving a mission type selection for the vehicle selection;
acquiring mission type data relating to the vehicle selection and the mission type selection, the mission type data comprising a list of a plurality of essential components of the vehicle selection, the plurality of essential components comprising a first essential component and a second essential component;
generating a first health value extrapolation of the first essential component and a second health value extrapolation of the second essential component;
generating a first risk profile for the vehicle selection and the mission type selection;
providing a first signal indicating a first highest risk of the first risk profile;
receiving a maintenance action selection for the first essential component;
generating a second risk profile based on the maintenance action selection; and
providing a second signal indicating a second highest risk of the second risk profile, the second highest risk being lesser than the first highest risk.

10. The maintenance planner of claim 9, wherein the computer program code further includes instructions for generating a third health value extrapolation based on the maintenance action selection.

11. The maintenance planner of claim 10, wherein generating the first risk profile comprises consolidating the first health value extrapolation and the second health value extrapolation, and wherein generating the second risk profile comprises consolidating the third health value extrapolation and the second health value extrapolation.

12. The maintenance planner of claim 9, wherein the mission type selection comprises a selected mission type and a risk level for the selected mission type.

13. The maintenance planner of claim 12, wherein the mission type data comprises a mission type schedule, wherein the mission type schedule comprises alternating usage periods and maintenance periods, and wherein the maintenance action selection comprises a selected maintenance period.

14. The maintenance planner of claim 9, wherein generating the second risk profile comprises shifting a portion of the first risk profile.

15. A maintenance planning system, comprising:
a vehicle profile of a vehicle, the vehicle profile comprising a maintenance outline for the vehicle, the maintenance outline comprising usage periods and maintenance periods;
a mission type profile of a mission type, the mission type profile comprising a timeline of the mission type, the timeline overlapping with a portion of the maintenance outline; and
a maintenance planner, the maintenance planner comprising:
a mission type selection step for selecting at least one of the vehicle or the mission type profile;
a component health analysis step for generating health value extrapolations for essential components of the vehicle;
a maintenance selection step for selecting maintenance actions to be performed during the maintenance periods; and
a vehicle risk analysis step for generating a risk profile based on the health value extrapolations and the maintenance actions.

16. The maintenance planning system of claim 15, wherein the mission type selection step of the maintenance planner identifies the essential components based on the vehicle and the mission type profile.

17. The maintenance planning system of claim 15, wherein the maintenance periods comprise a plurality of limited maintenance periods and a comprehensive maintenance period.

18. The maintenance planning system of claim 17, wherein selecting the maintenance actions comprises selecting the maintenance actions to be performed during the limited maintenance periods.

19. The maintenance planning system of claim 15, wherein generating the health value extrapolations comprises updating the health value extrapolations based on the selecting maintenance actions to be performed.

20. The maintenance planning system of claim 15, wherein generating the risk profile comprises adjusting a first risk profile to generate a second risk profile.
